(19) United States
(12) Patent Application Publication
(10) Pub. No.: US 2003/0022994 A1
(43) Pub. Date: Jan. 30, 2003

(54) Polymers having co-continuous architecture

(76) Inventors: Nobuyoshi Joe Maeji, Wishart (AU); Firas Rasoul, Westlake (AU); Peter Kambouris, Eight Mile Plains (AU); Liying Shao, Brookfield (AU); Michael Whittaker, Coogee (AU)

Correspondence Address: HOWREY SIMON ARNOLD & WHITE, LLP, BOX 34, 301 RAVENSWOOD AVE., MENLO PARK, CA, 94025, US

(21) Appl. No.: 10/052,907

(22) Filed: Jan. 17, 2002

(30) Foreign Application Priority Data
Jan. 18, 2001 (AU) PR2593
Jan. 17, 2002 (AU) PCT/AU02/00043

(51) Int. Cl. C08L 9/00; C08L 23/00; C08L 27/12

(52) U.S. Cl. 525/191; 525/199; 525/232; 525/240

(57) ABSTRACT

The present invention generally relates to polymers, including substrate polymers and hybrid polymers, having co-continuous architecture. The co-continuous architecture of the polymers of the present invention facilitates accessibility of functional groups to an external environment thereby making the polymers useful for a number of applications including solid phase chemistry, chromatography, and diagnostics. The present invention provides a number of methods for generating substrate polymers and hybrid polymers having co-continuous architecture including methods of grafting and macroporous formulation.

### FIELD OF THE INVENTION

The present invention relates generally to a polymer having co-continuous architecture. More particularly, the present invention is directed to a single or plurality of polymers in polymeric, co-polymeric, hybrid or blend formation comprising at least one polymer having co-continuous architecture. The co-continuous architecture of the one or more polymers permits or otherwise facilitates accessibility of functional groups to an external environment or at least one polymeric layer. The accessible, i.e. co-continuous, nature of the functional groups, in or on the one or more polymers facilitates solid phase chemical processes, chromatography and ion exchange applications. The one or more polymers may also be used as a solid support for a range of diagnostic applications. The present invention further provides a solid support comprising a substrate polymer and one or more further polymers each in pellicular formation with respect to each other and wherein the resulting hybrid polymer comprises a polymer layer which is co-continuous with respect to the substrate polymer and functional groups thereon relative to a solution or solvent phase or other environmental medium surrounding the hybrid polymer. In one form, the co-continuous architecture of a polymer is said to be a polymer having porous-like properties. The present invention further contemplates a method for generating polymers having co-continuous architecture and their use inter alia in solid phase processes including solid phase chemical processes, chromatography and ion exchange as well as their use in a range of diagnostic applications. The present invention further provides a hybrid polymer having two or more polymers in pellicular formation and comprising a polymer layer which is co-continuous with respect to functional groups thereon and the surrounding environment and having a substrate polymer portion with a mouldable shape with a particular mechanical strength and an ability to protect polymeric and/or functional chemical reactivities grafted thereto. In one preferred embodiment, the present invention provides co-continuous architecture formation through use of non-complementary polymers where at least one polymer or co-polymer in a blend of polymers is removable by extraction, solvation or any other chemical or physical means such as but not limited to hydrolysis or degradation. The present invention also provides a polymer having co-continuous architecture in hybrid formation with a rigid basement substrate.

### BACKGROUND OF THE INVENTION

Bibliographic details of the publications referred to by author in this specification are collected at the end of the description.

The increasing sophistication of organic synthesis including combinatorial chemistry and recombinant DNA processes is greatly facilitating research and development in the chemical and biological industries. Of particular importance is the rapidly growing industry involving diagnostic and screening processes. Such processes are useful for diagnosing a range of human and animal disease conditions and hereditary traits. Furthermore, natural product screening is now considered a fundamental approach for identifying potentially new therapeutic agents.

Central to developing diagnostic and screening processes is the need for suitable solid supports as well as matrices for combinatorial chemical processes and immunological, biochemical and/or nucleic acid interactions.

High throughput parallel synthesis and/or combinatorial chemistry approaches to compound synthesis have dramatically changed the process of identifying and optimizing compounds for drug discovery. With these methodologies, large sets of compounds are synthesized in parallel as discrete compounds or as mixtures. These methodologies include solid phase synthesis as well as solution phase processing. Some methodologies require the use of solid phase reagents and/or scavengers as part of the synthesis process. Methods which include parallel synthesis of individual compounds are preferred over synthesis in mixtures. In terms of numbers of compounds handled in parallel, solid phase methodologies have advantages over solution phase methods.

There are a number of methods for the parallel synthesis of discrete compounds by solid phase methodologies. One approach is the “Split and Combine” method of synthesis wherein large numbers of individual beads are equally divided into separate reaction vessels and each is reacted with a single different reactor. After completion of the initial reactions and subsequent washings to remove excess reagents, the individual resin beads are recombined and mixed thoroughly and redivided into separate reaction vessels. Reactions with a further set of reagents gives a complete set of potential dimers. The process may be repeated as required.

Solid phase synthesis may be conducted on membranes. For example, International Patent Publication No. WO 90/02749 discloses the synthesis of peptides upon a polymer substrate (e.g. a polyethylene substrate). The polyethylene substrate is generally in the form of a sheet or film to which polystyrene chains have been grafted.

Solid phase synthesis requires an appropriate choice of solid support. For example, in oligonucleotide synthesis, the preferred solid support is controlled pore glass (CPG). With this material, the quantity of oligonucleotide synthesized is dependent on the total surface area within the porous structure in the glass, which, is relatively low capacity. In peptide synthesis, the predominant solid supports are low cross-linked polystyrene (PS) or polyethyleneglycol-polystyrene (PEG-PS) graft beads. These materials have far greater loading capacities as they do not have constant porous structures and, depending on compatible solvents, can form a swollen network. The high loading capacity and high reaction kinetics is principally due to the high mobility of a swollen polymer state. This type of solid phase is also called a microporous resin and is produced by adding 1-2% of a cross-linking agent to make a mobile linear polymer having some minimum structural integrity while maintaining maximum polymer mobility. One example of a microporous support is 1% v/v divinylbenzene/polystyrene (1% DVB/PS) but there are many other microporous type supports. All are based on the minimum necessary cross-linking to maintain some bead shape while maximizing polymer mobility. As a consequence, they are all soft and can be easily deformed or damaged.

Furthermore, polymeric solid supports may exhibit different properties depending on the batch produced. Such lot-to-lot variation introduces disadvantageous levels of unpredictability.

Combinatorial solid phase organic synthesis permits a number of possible chemistries for small molecule synthesis (as opposed to synthesis of biopolymers). However, as with any solid phase method, the success of solid phase organic synthesis (SPOS) is very dependent on the type of solid support that is used. Certain reactions perform better with PS beads compared to PEG-PS and vice versa. As any compound synthesis will require a number of reaction steps, conventional solution phase chemistry generally involves the use of different solvents at different steps in the synthesis process. However, in solid phase applications, there is the extra complication that all these different solvents also have to be compatible with the solid phase. Compatible solvents give a swollen network. Non-compatible solvents will collapse the solid phase leading to poor reactivity and subsequent failure in synthesis. There is no microporous resin that swells in all solvents. As a consequence, there are major incompatibilities between traditional solution phase and solid phase procedures for general organic chemistry.

More effective correlation between solution and solid phase methodologies, may be obtained by using rigid solid phase materials that do not significantly swell or collapse in different solvents. The desired materials comprise functional groups that remain accessible as solvent conditions change. Materials which maintain a rigid permanent porous structure, are needed. Such materials have been generated by the incorporation of >20% cross-linking agents, and are principally used as ion-exchange resins, for catalysts, adsorbants and chromatographic media. The surfaces of these pores can be accessed by essentially all solvents. Water, for example, can penetrate macroporous DVB/PS while this would be impossible with microporous materials. Although these rigid materials are receiving considerable interest as supports for solid phase synthesis and as supports for reagents and scavengers in solution phase synthesis, they are not mechanically robust. Furthermore, like CPG, the loading density of these materials is dependent on total surface area. Consequently, achieving higher loading densities requires the use of smaller pore sizes, resulting in a decrease in reaction kinetics. Therefore, despite their potential for achieving greater compatibility with solution phase procedures, these materials are not well-suited for solid phase synthesis, principally due to their high heterogeneity of composition and concomitant slow and/or uneven reaction kinetics (Sherrington, D., 1998; Hori et al., 1998).

Attempts have been made to overcome the problems of high heterogeneity through the use of another type of solid phase, known as a pellicular type, wherein a mobile polymer was grafted to a rigid plastic. The goal was to obtain long linear polystyrene chains, with minimum cross-linking, grafted to the substrate polymer (PP or Teflon type). Ideally, the goal was 0% cross-linking because the PS chains are rendered insoluble by being covalently anchored to the substrate polymer. Traditional low-cross-linked (microporous) beads had molecular weights between cross-links on the order of 10⁴. Instead, the aim was to have a greater molecular weight (10⁶), such that these linear chains would be more readily solvated in organic solvents, thereby maximizing the quantity of graft polymer to increasing the total loading capacity.

However, as long as the goal was to maximize the formation of linear PS and increase loading capacity, the same problems encountered with low cross-linked, or microporous supports, remained. These graft polymers also swelled and collapsed in different solvents, leading to incompatibilities between traditional solution phase and solid phase conditions in organic synthesis (Tregear et al., 1972; Berg et al., 1989; Schaaper et al., 1992; Maeji et al., 1994 and Zhao et al., 1999). Furthermore, traditional radiation grafting provides growth of polymers outwards from the site of radical induction as well as inwards into the bulk of the substrate. This can result in a heterogenous film with different kinetics and washout characteristics. Furthermore, conventional grafting procedures, while providing films with high densities, have inaccessible sites for bulky biologically relevant targets.

In the present invention, the inventors have identified an alternative to increasing total molecular weight. Namely increasing accessibility via increasing the surface area which, leads to more of the surface area being continuous with the external environment. Such a state is referred to herein as “co-continuous”. The present invention provides methods of modifying the surface of a polymer substrate to facilitate the formation of co-continuous and co-continuous-like architectures. These co-continuous polymer substrate systems possess the desired strength without loss of functionality. The instant invention provides hybrid polymers in pellicular formation with the modified substrate to facilitate co-continuity between the functional groups on the substrate polymer and/or on grafted polymers and the external environment.

### SUMMARY OF THE INVENTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

The present invention relates generally to the generation of substrate polymers, or a single polymer, or a hybrid of one or a plurality of polymers, with co-continuous architecture and other properties. In particular, the present invention provides one or a plurality of polymers in polymeric, co-polymeric, hybrid or blend formation comprising at least one polymer layer having co-continuous architecture, wherein “co-continuous” means that accessibility of functional groups to an external environment is facilitated.

Even a planar polymeric surface may comprise functional groups co-continuous with an external environment by virtue of its comprising a multiplicity of pores or porous-like structures. The pores or porous-like structures may exist singly or each porous region may comprise multiple pores or porous-like structures, resulting in a potentially highly extensive surface onto, into or from which functional groups, when attached, comprise an internal architecture which is co-continuous with the external environment.

The accessibility of functional groups therein to an external environment (i.e. co-continuity) facilitates solid phase chemical processes, chromatography and ion exchange applications. The one or plurality of polymers may also be used as solid supports, for a range of diagnostic applications. The solid support may comprise a substrate polymer and one or more further polymers each in pellicular formation with respect to each other wherein the resulting hybrid polymer comprises a polymer layer and functional groups thereon which is co-continuous relative to a solution or solvent phase or other environmental medium surrounding the hybrid polymer.

Accordingly, the present invention provides a substrate polymer comprising a surface modified to facilitate co-continuity of functional groups to an external environment.

The substrate polymer may also be in the form of a hybrid polymer, comprising one or a plurality of grafted polymers in pellicular formation. At least one polymer in the hybrid polymer maintains the co-continuous character of functional groups of said polymer to an external environment.

In a preferred embodiment, the hybrid polymer comprises a substrate polymer and one or a plurality of polymers grafted thereto, wherein the substrate polymer has the characteristics of a hardness value of from about Hardness Shore “A” 5 to about Hardness Shore “D” 100 and a Flexural Modulus Value of from about 50 to about 2000 Mpa.

The present invention further contemplates a process for generating a hybrid polymer with a co-continuous character useful as a substrate for solid phase applications. The process generally comprises grafting a polymer to a substrate polymer, wherein the grafted polymer is sufficiently rigid to permit access of individual functional groups in or within said hybrid polymer to an external environment.

In a preferred method, the hybrid polymer is generated by subjecting a substrate polymer, or surface or sub-surface region thereof, to sufficient physical stress means to enable the substrate polymer or regions thereof to act as a substrate for the grafting of another polymer or group or series of other polymers or monomeric subunits thereof. The latter is then subjected to conditions sufficient for the other one or more polymers to form a thin layer having co-continuous properties.

The present invention further contemplates a method for generating a hybrid polymer comprising a substrate polymer with one or more further polymers grafted to surface and/or sub-surface regions thereof. Optionally, the one or more further polymers may be grafted to the surface and/or sub-surface in an array of discrete regions. The method for generating such a hybrid polymer of one or more further polymers grafted to surface and/or sub-surface regions of the substrate polymer comprises subjecting discrete regions of the substrate polymer surface and/or sub-surface to physical stress, and contacting the treated substrate polymer with the one or more further polymers under conditions sufficient to cause them to graft to the substrate polymer. Further, the invention includes a method of generating a hybrid polymer of one or more further polymers with co-continuous character, optionally in an array format, comprising grafting one or more further polymers to surface and/or sub-surface regions of the substrate polymer, wherein at least one grafted polymer maintains the co-continuous character of functional groups of the hybrid polymer. Preferably, the one or more further grafted polymers is sufficiently rigid to permit access of individual functional groups in or within the hybrid polymer to an external environment.

### DETAILED DESCRIPTION OF THE PREFERRED EMBODIMENTS

The present invention is predicated in part on the generation of substrate polymers or a single polymer or a hybrid of one or a plurality of polymers with co-continuous architecture and other properties. The substrate polymer or at least one of a plurality of polymers comprises functional groups freely accessible, i.e. co-continuous, to the external environment.

Accordingly, one aspect of the present invention provides a substrate polymer comprising a polymer with a surface modified to facilitate co-continuity of functional groups to an external environment.

Reference to the “external environment” in this context includes a surrounding solvent, solution or other liquid, solid or gaseous environment comprising, for example, reactive entities relative to the functional groups or any reactive groups attached thereto.

A solvent is any liquid phase in which reactants are dissolved, suspended or dispersed in the liquid medium. Solvents include but are not limited to polar or non-polar, protic or aprotic solvents such as hydrocarbons (e.g. petroleum ethers, benzene, toluene, , hexane, cyclohexane), chlorinated solvents (e.g. dichloromethane, carbon tetrachloride) and other halogenated solvents including fluorinated or brominated solvents, dialkyl ethers (e.g. diethyl ether, tetrahydrofuoran), alcohols (e.g. methanol, ethanol, propanol and butanol), acetonitrile, ethyl acetate and in some cases, aqueous media, including physiological buffer solutions or water alone.

As used herein, the term “polymer” includes any polymer, copolymers or other form of multi-polymeric material including blends of polymers or co-polymers. The term “polymer” is not limited to synthetic compositions by also includes natural polymers and their analogs, e.g., lipid bilayers, carbohydrates, polyketides, polynucleotides, polypeptides, proteins, nucleic acids, peptide nucleic acids, and phosphorothioate polymers.

Substrate polymers useful with the present invention include any polymers that may be used in solid phase processes without further modification, or that may be subject to grafting conditions wherein one or more further polymers are grafted to the substrate polymer in pellicular formation. The substrate polymer need not be limited in its structural characteristics or chemical composition.

A substrate polymer of the present invention includes any polymer or any point, area or other region on the surface or sub-surface of a polymer which is capable of forming an association or other form of graft with another polymer or with the same polymer. Reference herein to a “sub-surface” includes an interior or interior region or any indentation in the average planar line formed on the surface of polymer. Reference herein to a particular point, area or other region of a substrate polymer means a selected surface, sub-surface areas, or interior areas of a substrate polymer that may be subjected to grafting with the same or different polymers in a random or patterned array. The term “region” includes a point or area on the surface or sub-surface of the substrate polymer. A substrate polymer in one sense may be regarded herein as forming an exoskeleton.

Substrate polymers of the present invention may include any polymer having a shape or other properties which facilitate a particular application and/or which facilitates protection of a polymer grafted thereto. The substrate polymer optionally comprises a co-continuous porous or filamentous structure or may be rendered co-continuous prior to involvement in grafting. In preferred embodiments, after hybrid polymer formation, at least one polymer layer comprises functional groups which remain co-continuous with an external environment.

Preferably, the substrate polymer is of sufficient mechanical strength for its particular application. Any subsequent grafted polymers are generally required to be of sufficient strength to permit a co-continuous character within the requirements of the solid support. In one useful embodiment, there is sufficient rigidity to allow a co-continuous character within the requirements of the solid support.

Generally, the substrate polymer, and/or any hybrid polymers formed therefrom, may be any shape including linear, curved, circular or planar forms, beads and/or wells. In some embodiments, mouldable shapes with high surface area may be used. In one embodiment, substrate polymers, and/or any hybrid polymers, of the present invention may be formed by placing moulded plastics in a desired solvent, that optionally further comprises one or more polymers or monomeric units of polymers. Alternatively or in addition, the present invention includes substrate polymers, and/or any hybrid polymers formed therefrom, that may be generated in a gaseous environment, such as in the formation of foam.

The substrate polymer, and any hybrid polymeric compositions formed with the substrate polymer, are particularly useful for solid phase processes due to co-continuous character generated within or on the substrate polymer and subsequent grafted polymers. The co-continuous character is inherent in a rigid porous structure, which has minimal swelling, i.e. non-collapsing properties. In preferred embodiments, the substrate or hybrid polymer is also of sufficient mechanical strength to minimize distortion during physical stress.

Particularly useful substrate polymers include but are not limited to polyethylene, polypropylene, fluoropolymers or blends of polymers or copolymers. Reference herein to a copolymer includes a polymer comprising two or more monomers. The term “polymer” includes copolymers and blends of polymers or copolymers.

Particularly useful substrate polymers are polyolefins and fluorinated polymers having the following characteristics:a hardness value of from about Hardness Shore “A” 5 to about Hardness Shore “D” 100, preferably from about Hardness Shore “A” 10 to about Hardness Shore “D” 80, more preferably from about Hardness Shore “A” 20 to about Hardness Shore “D” 70 and even more preferably from Hardness Shore “A” 35 to about Hardness Shore “D” 60; and a Flexural Modulus Value of from about 50 to about 2000 Mpa, preferably from about 100 to about 1600 Mpa and even more preferably from about 300 to about 1200 Mpa.

In a particularly preferred embodiment the Hardness value is Hardness Shore “D” 68.

In another particularly preferred embodiment, the Hardness value is Hardness Shore “D” 68 and, the Flexural Modulus Value is from about 80 to 1200 Mpa.

As stated above, the substrate polymer may form or be mouldable to any shape. Shapes and forms of the substrate polymer contemplated herein are any other moulded shape consistent with forming co-continuous structures, such as formats of a slide, stick, block, net, disc, cylinder, pyramid, star, donut, wheel, cog, cube, cage, rod or sphere and other functional geometries, which afford a surface area per square centimetre of 0.1 to 10,000, preferably 0.5 to 1,000 and more preferably 0.8 to 100. Such shapes may be continuous, in that they are solid throughout as, for example, in the case of a block, or they may be interrupted, such as are a donut and a net.

Preferred shapes are those that do not adversely affect the reaction profile of the substrate polymer, when it is involved in solid phase chemical synthesis processes. Particularly preferred shapes are those that enhance the reaction profile of the substrate.

The present invention further provides a hybrid polymer comprising a substrate polymer in pellicular formation with one or more grafted polymers to form a hybrid polymer structure having a co-continuous structure.

In a preferred embodiment, the present invention provides a hybrid polymer comprising a substrate polymer with a surface modified to facilitate co-continuity of functional groups to an external environment, and one or a plurality of grafted polymers in pellicular formation, wherein at least one polymer in the hybrid polymer maintains the co-continuous character of functional groups to an external environment.

In another preferred embodiment, the hybrid polymer comprises a substrate polymer and one or a plurality of polymers grafted thereto wherein the substrate polymer comprises a polymer having the characteristics: a hardness value of from about Hardness Shore “A” 5 to about Hardness Shore “D” 100; a Flexural Modulus Value of from about 50 to about 2000 Mpa; and, wherein the one or a plurality of polymers grafted thereto maintain the co-continuous character of functional groups of said polymer to an external environment.

Preferably, the hybrid polymer is in the form of a cylinder, film, sheet, bead or disc or any other shape consistent with forming co-continuous structures.

According to this and other aspects of the present invention, the polymers that form a hybrid polymer may include both the same polymer as the substrate polymer or a polymer chemically, physically or functionally distinct from the substrate polymer. A “functionally” distinct polymer includes a polymer which has the same chemical constituency as the substrate polymer but has been subjected to physical or chemical conditions such that its properties (e.g. the ability to participate in graft formation) have been altered. Where polymers differ from the substrate polymer, they may comprise all the same polymers or may comprise a population of two or more different polymers.

The present invention further contemplates a hybrid polymer comprising a first polymer in hybrid formation with a second or optionally further polymers wherein the first polymer or surface or sub-surface regions thereof are subjected to physical stress to render same suitable for receiving a graft of the second or optionally further polymers and wherein the second or optionally further polymers exhibit co-continuous-like properties.

More particularly, the present invention further contemplates a hybrid polymer comprising a first polymer in hybrid formation with a second or optionally further polymers wherein the first polymer or surface or sub-surface regions thereof is subjected to physical stress that renders it suitable for receiving a graft of the second or optionally further polymers and wherein the second or optionally further polymers are grafted under conditions which facilitate the co-continuous character of the hybrid polymer.

The terms “treatment”, “treat” or “treating” generally refer to subjecting a polymer or group of polymers to physical or chemical conditions that permit a particular outcome. A “treated substrate polymer”, for example, may refer to a substrate polymer subjected to physical stress that render it suitable to participate in graft formation. Alternatively, it also may apply to chemical or physical conditions required to effect grafting including inducing polymerization of the monomeric unit during or prior to grafting to the substrate polymer.

Terms such as “co-continuous structure”, “co-continuous architecture”, “co-continuous character” and “co-continuous-like properties” are used interchangeably throughout the subject specification.

The present invention further contemplates a process for generating a hybrid polymer useful as a substrate for solid phase applications, said process comprising grafting a polymer which is sufficiently rigid to maintain the co-continuous character of functional groups of the hybrid polymer with respect to the external environment. In a related embodiment, the present invention further provides a process for generating a hybrid polymer with a co-continuous character useful as a substrate for solid phase applications, said process comprising grafting a polymer to a substrate polymer wherein said grafted polymer is sufficiently rigid to permit access of individual functional groups in or within said hybrid polymer to an external environment.

Without limiting the present invention to any one theory or mode of action, a structure with a co-continuous character may be produced by grafting the polymers under conditions that optimize uniformity of coating while maintaining a relatively low linear molecular weight (between cross-links).

Reference to “grafting” or “grafted polymers” as used herein, does not imply any limitation a particular process by which two polymers associate. Rather grafting may be considered to include any process by which a high density of free radical formation is used to initiate polymerization of monomer units. Generally, but not exclusively, the polymerization of the monomeric units occurs prior to or during polymeric hybrid formation between the polymerized monomeric units and a substrate polymer.

The grafted polymer preferably forms a relatively thin layer on or within the substrate polymer. Such a thin layer maximizes diffusion of reactant molecules applied thereto and maintains co-continuous structures. In a preferred embodiment, the grafted polymer is a monolayer or a multilayer up to about 100 microns thick, more preferably up to about 50 microns thick, and even more preferably up to about 20 microns thick.

Preferably, the grafted hybrid polymer comprises at least one layer of less than about 10 microns, preferably less than about 5 microns and even more preferably less than about 3 microns such as about 2 microns or less. Preferably, the layer having the above-mentioned width is the penultimate layer within the hybrid.

Preferably, the polymers are grafted under conditions that result in increased uniformity of coating and decreased linear molecular weight (between crosslinks). Importantly, the polymeric architecture should preferably maintain sufficient rigidity, while allowing mobility of individual functional groups within the grafted polymer. Further, the rigidity of the substrate polymer should preferably provide accessibility throughout the co-continuous grafted layer, thereby creating reaction conditions close to those that occur in the solution, as well as effecting a highly efficient flux of solvent after each step.

Furthermore, where a plurality of polymers are grafted in pellicular formation with respect to each other, the pore size in each subsequent polymer layer is preferably but not necessarily smaller than the pore size of the layer upon which it is grafted. Reference herein to “pellicular” is not to imply any limitation as to size and is generally but not necessarily visible at the microscopic or optionally macroscopic level.

In the context of the present invention, the grafting procedure may be carried out by any convenient means. In one particular embodiment, the grafting procedure involves subjecting the substrate polymer to physical stress.

The term “physical stress” as used herein refers to any form of pressure or force achieved by applying energy to the polymer. The term “physical stress” is also encompassed by the expression “physical stress means”.

A measure of sufficient physical stress is conveniently determined by the ability of a polymer, initially under conditions or in a form being substantially incapable of receiving a graft, to alter its characteristics to permit graft or other hybrid formation. Although not intending to limit the present invention to any one theory or mode of action, it is proposed that the physical stress alters one or more chemical bonds or spatially alters polymeric chains to permit hybrid formation with another or the same polymer.

Examples of physical stress include but are not limited to application of energy by physical movement of the polymers, e.g. by stretching, twisting, indenting, bending, compressing, scratching or cutting. Physical stress may also include ejection from a mould.

Physical stress also encompasses application of energy from a radiation or particle source, including e.g. atomic particles; all forms of electromagnetic radiation, including e.g., X-ray, ultraviolet (e.g UV and vacuum UV), visible, infra-red (e.g. near and far-I.R.) or microwave radiation; plasma discharge irradiation; all forms of ionizing radiation, including e.g., y-radiation and electron beam radiation; and thermal radiation (e.g. exposure to increased temperature). Exposure to forms of electromagnetic radiation may be from any source including e.g. lamps or lasers.

Physical stress also encompasses application of chemical energy, including e.g. chemically-induced grafting.

The physical stress means may be applied to the entire substrate polymer or to selected or random points or areas including regions thereof. As a result of the physical stress means process, stress may also be applied to or cause fissures, indentations or openings to sub-surface regions. Accordingly, the physical stress is said to be applied to the substrate polymer or surface or sub-surface regions thereof.

Accordingly, another aspect of the present invention contemplates a method for generating a hybrid polymer having a polymeric portion exhibiting a co-continuous character, said method comprising subjecting a substrate polymer or surface or sub-surface regions thereof to sufficient physical stress means to enable the substrate polymer or regions thereof to act as a substrate for the grafting of another polymer or group or series of other polymers or monomeric subunits thereof and subjecting same to conditions sufficient for said other one or more polymers to form a thin layer having co-continuous properties.

In a related embodiment, the present invention provides a method for generating a hybrid exhibiting co-continuous character, said method comprising subjecting a substrate polymer to physical stress sufficient to graft one or more other polymers or monomeric units thereof and subjecting same to conditions sufficient for said one or more polymers or monomeric units thereof to form a thin layer having co-continuous properties.

Preferably, the grafted hybrid polymer comprises a polymer layer such as a penultimate layer of less than 10 microns, preferably less than 5 microns and more preferably less than 3 microns such as 2 microns or less.

Polymers contemplated herein for use as substrate or grafted polymers include, but are not limited to, the following four types:

I. Polymers which contain functional groups due to the presence of functional groups in the respective monomers, such as acrylic (or methacrylic) acid esters having a free functionality in the alcohol part of the ester function, e.g. —(CH₂)ₙCH₂—OH, —(CH₂)ₙCH(CH₃)—OH (n=2-10) or an active ester function such as —COOR, R being e.g. pentafluorophenyl, p-nitrophenyl, methoxymethylene or a lactone function, which directly can react with a nucleophile. Similar types of polymers can be obtained by crosslinking dialkylsilandiols or polydialkylsiloxanes, polyvinylalcohol, polyoxymethylene or polyoxyethylene with suitable crosslinking agents such as terephthaldehyde, carboxylic acid dichlorides or bisisothiocyanates.

II. Polymers in which functional groups can be introduced by chemical modifications such as crosslinked polystyrene, polysulfone containing aromatic residues, polyesters, polyamides, polyimides, polycarbonates, polyvinylacetate. Polymers with aromatic residues can be modified, e.g. Friedel-Crafts acylation followed by reduction or Grignard reaction. Other types of polymers can generate free functional groups by partial hydrolytic reactions. Polyvinylidene difluoride (PVDF) can generate functional groups (double bonds) by dehydrohalogenation.

III. Chemically inert polymers such as polysulfones, polytetrafluoroethylene (Teflon trademark), polyethylene, polypropylene, polyvinylidene difluoride (PVDF) can be activated by radiation, e.g. with high energy UV or Cobalt-60 and the generated ions or radicals used for grafting onto the surface of the polymer, chains containing monomers with functional groups according to I and/or II.

IV. Chemically inert polymers such as polysulfones, polytetrafluorethylene (Teflon trademark), polyethylene, polypropylene, polyvinylidene difluoride (PVDF) can be coated with copolymers, which already do contain free functional groups (I) or easily transformed to generate functional groups by using conventional chemical or physico-chemical processes (II, III). Another subtype could be obtained by crosslinking, e.g. polyvinylalcohol on the surface of the aforementioned polymers, generating diradicals and use the radicals to start a grafting processing involving monomers according to I and/or II.

In another embodiment of the present invention, a substrate polymer may be used comprising two or more copolymers or blends of polymers, which are substantially incompatible with each other. Upon subjecting this copolymeric substrate or blend to extraction, solvation or any other chemical or physical means such as but not limited to hydrolysis and/or degradation, one or more polymers are removed generally resulting in porous-like structures. In one embodiment, the porous-like structures are macroporous or macroporous-like.

In a preferred embodiment, two polymers such as but not limited to, for example, polypropylene and polystyrene, form an incompatible blend. Other examples of incompatible blends include, but are not limited to, polydimethylsiloxane with polystyrene; polydimethylsiloxane with methyl methacrylate; nylon with polypropylene; perfluoropolyether with polystyrene; polyethylene with polystyrene; polyethylene with ethylene vinyl acetate; polyethylene with polyvinyl alcohol; polyvinyl acetate with polypropylene; and polyvinyl acetate with polyethylene. The blend is subsequently extracted using any suitable solvent. The resulting hybrid polymer exhibits a co-continuous and macroporous structure. This procedure describes one method suitable for the generation of a macroporous or macroporous-like substrate polymer. Various other means of generating macroporous or macroporous-like structures are known in the art and include, for example, those described in International Patent Publication Numbers WO90/07575 and WO91/07687 and in U.S. Pat. Nos. 5,244,799, 5,238,613 and 4,799,931, for the introduction of porosity into synthetic polymers. Such extracted porous polymeric articles may subsequently be subjected to a range of different grafting procedures.

Alternatively, the porosity may be an inherent property of the polymer and the porosity maintained as the polymer is formed into the desired shape for a particular application.

It is particularly advantageous for the porosity to be introduced during the polymer forming steps. This is generally economical and, in appropriate cases, good control over the porosity and pore size is achieved.

In certain polymers, porosity may be an interpenetrating network of holes, open cells or a combination thereof. Another method of generating macroporous polymers involves polymerization in the presence of an insoluble material, often referred to as a porogen. Subsequent leaching of the porogen gives rise to interstices throughout the formed polymer material. Hence the resulting polymer material is rendered macroporous via the addition of a porogen. Such a process is described by Frechet and Elmes in U.S. Pat. Nos. 5,130,343 and 4,985,468, respectively.

Another method of obtaining porous materials is the polymerization of co-continuous microemulsions. Microemulsion polymerization involves the polymerization of a stable isotropic mixture of an oil phase and a water phase stabilized by surfactants. The oil phase generally contains the polymerizable monomer, which polymerizes around either contiguous droplets of the water phase stabilized by surfactants or about a co-continuous water phase. Typically, organic solvents are not used in the water phase. Such a process is described by Chaouk in U.S. Pat. No. 6,060,530.

In another embodiment, the grafted polymer in the hybrid polymer is generated from a high internal phase emulsion (HIPE), and is referred to herein as a polyHIPE or polyHIPE-like polymer. Such emulsions, when comprised of monomer, porogen, initiator and surfactant, afford macroporous materials. Such cured emulsions are known as polyHIPE, and are described by Barby and Haq in European Patent 0,060,138.

All of the above methods are included herein as macroporous formulation means, and may be utilized to generate substrate and/or hybrid polymers that exhibit the characteristics of macroporosity.

The present invention further provides one or more components, compounds, reagents and/or solvents in kit or package form with instructions for generation of the subject hybrid polymers.

Polymers used to generate porous polymer films comprise characteristics such that, in forming films, they produce a self-organised honeycomb morphology. Such a morphology is particularly useful in the preparation of the co-continuous macroporous hybrid polymers of the present invention.

Such a porous polymer film may be cast onto a substrate polymer or surface or sub-surface regions thereof to yield a hybrid polymer comprising a thin layer having co-continuous properties, from or onto which one or more polymers or monomeric subunits thereof may be grafted. The films, which are 3-10 μm thick, are produced by evaporating solutions of star-shaped polystyrene or polystyrene or polystyrene-polyparaphenylene block copolymers in carbon disulphide under a flow of moist gas (as described in, for example, Widawski et al., 1994).

In a preferred embodiment, a “star polymer”, having a central core and three or more radiating polymeric arms, is utilized. Such porous polymer films may be cast from a solution of star polymer in an organic solvent. In an alternative embodiment, two or more of the radiating polymeric arms of a “star polymer” may comprise at least one reactive moiety and, hence, they may cross-link with arms of an adjacent star polymer to form a film.

Generally, a hybrid polymer of the present invention comprises a substrate polymer and at least a second polymer grafted onto said substrate polymer. Preferably, the second polymer before or after grafting exhibits co-continuous-like properties. In one preferred embodiment, the second polymer comprises star polymers cast to form a porous polymer film having a honeycomb-like morphology.

In another aspect of the present invention, grafted polymers may also form an array. The term “array” may or may not require the identification of a grafted polymer in terms of coordinates for its location. An array may be in a pattern or be random and may comprise all the same polymer or two or more polymers. The surface of a substrate polymer may be uniformly able to accept a graft polymer or different regions may be graftable or non-graftable. In either event, the preferred grafted polymer is in an array format.

As used herein, a “region” of a substrate polymer includes a point, area or other location on the surface or sub-surface of the polymer. The population or array of polymers grafted on the substrate polymer occupies, in one embodiment, discrete regions onto the surface and optionally sub-surface of the substrate polymer.

Generally, the first polymer in this aspect of the present invention is regarded as a “substrate” polymer. As described above, “grafting” includes a process whereby a first polymer is brought into hybrid formation with a second or optionally further polymers. This process may be repeated to form multiple layers of grafted material optionally each with different properties.

As used herein, the terms “graft polymer” and “comb polymer” are interchangeable. Both terms refer to a graft polymer comprising a polymeric substrate, which may be of one monomer type or may be a block copolymer, to which a further polymeric chain, which may also be of one monomer type or may be a block copolymer, is grafted. Usually this grafting occurs through pendent reactive, functional or polymerizable groups present on the substrate polymer, or through unsaturation of the substrate polymer.

Preferably, the second and optionally further polymers are in pellicular formation with respect to each other and at least one polymer (e.g. penultimate polymer layer) maintains a co-continuous character between functional groups thereon and an external environment.

Accordingly, another aspect of the present invention provides a method for generating a hybrid polymer comprising a substrate polymer and a second or optionally further polymers grafted to a surface and/or sub-surface of said substrate polymer in discrete regions, that may optionally form an array of second or further polymers. This method comprises: subjecting said substrate polymer, or specific surface and sub-surface regions thereof, to sufficient physical stress to enable the substrate polymer or its regions to form a hybrid with said second or optionally further polymers, or monomeric units thereof, and contacting said treated substrate polymer with said second or optionally further polymers under conditions sufficient for the second or optionally further polymers to graft to said substrate polymer or regions thereof. The second or further polymers thereby is generated in hybrid formation with the surface and/or sub-surface of said substrate polymer in discrete regions, that may optionally form an array, wherein the co-continuous character of functional groups of said polymer to an external environment is maintained for at least one polymer in the hybrid polymer.

According to this aspect of the present invention, there is provided a method for generating a hybrid polymer comprising a substrate polymer and a second or optionally further polymers grafted to a surface and/or sub-surface regions of said substrate polymer optionally in an array, said method comprising: subjecting said substrate polymer or surface and sub-surface regions thereof to sufficient physical stress to enable the substrate polymer or its regions to form a hybrid with said second or optionally further polymers or monomeric units thereof, contacting said treated substrate polymer with said second or optionally further polymers under conditions sufficient for the second or optionally further polymers to graft to said substrate polymer or regions thereof, whereby said second or optionally further polymer is grafted to the surface and/or sub-surface regions of said substrate polymer wherein at least one polymer in the hybrid polymer maintains the co-continuous character of functional groups of said polymer to an external environment.

According to this aspect of the present invention, the second or optionally further polymers that form a hybrid polymer includes both the same polymer as the substrate polymer or a polymer chemically, physically or functionally distinct from said substrate polymer. A “functionally” distinct polymer is as defined above and includes a polymer which has the same chemical constituency as the substrate polymer but has been subjected to physical or chemical conditions such that its properties (e.g. the ability to participate in graft formation) have been altered. Where a second or optionally further polymers differ from the substrate polymer, they may comprise all the same polymers or may comprise a population of two or more different polymers.

As an alternative to a hybrid polymer with discrete polymer regions in an array, a continuous layer may be formed wherein said continuous layer has co-continuous properties.

In one embodiment, the second or optionally further polymers or monomeric units thereof comprise a star polymer grafted to the surface and/or sub-surface regions of said substrate polymer, forming a hybrid polymer. In this embodiment, the co-continuous character of the hybrid polymer is maintained by virtue of the co-continuous properties of the honeycomb-like morphology of the porous polymer film formed from the star polymer.

Generally, the first polymer is regarded as a substrate polymer and may be regarded as forming an exoskeleton. As stated above, the substrate polymer may also be a foam.

A range of chemical reactions may be undertaken on the hybrid polymers of the present invention. Such chemical reactions include, for example:

i. [2+2] cycloadditions including trapping of butadiene;

ii. [2+3] cycloadditions including synthesis of isoxazolines, furans and modified peptides;

iii. acetal formation including immobilization of diols, aldehydes and ketones;

iv. aldol condensation including derivatization of aldehydes, synthesis of propanediols;

v. benzoin condensation including derivatization of aldehydes;

vi. cyclocondensations including benzodiazepines and hydantoins, thiazolidines, β-turn mimetics, porphyrins, phthalocyanines;

vii. Dieckmann cyclization including cyclization of diesters;

viii. Diels-Alder reaction including derivatization of acrylic acid;

ix. electrophilic addition including addition of alcohols to alkenes;

x. Grignard reaction including derivatization of aldehydes;

xi. Heck reaction including synthesis of disubstituted alkenes;

xii. Henry reaction including synthesis of nitrile oxides in situ (see [2+3] cycloaddition);

xiii. catalytic hydrogenation including synthesis of pheromones and peptides (hydrogenation of alkenes);

xiv. Michael reaction including synthesis of sulfanyl ketones, bicyclo[2.2.2] octanes;

xv. Mitsunobu reaction including synthesis of aryl ethers, peptidyl phosphonates and thioethers;

xvi. nucleophilic aromatic substitutions including synthesis of quinolones;

xvii. oxidation including synthesis of aldehydes and ketones;

xviii. Pausen-Khand cycloaddition including cyclization of norbomadiene with pentynol;

xix. photochemical cyclization including synthesis of helicenes;

xx. reactions with organometallic compounds including derivatization of aldehydes and acyl chlorides;

xxi. reduction with complex hydrides and tin compounds including reduction of carbonyl, carboxylic acids, esters and nitro groups;

xxii. Soai reaction including reduction of carboxyl groups;

xxiii. Stille reactions including synthesis of biphenyl derivaives;

xxiv. Stork reactions including synthesis of substituted cyclohexanones;

xxv. reductive amination including synthesis of quinolones;

xxvi. Suzuki reaction including synthesis of phenylacetic acid derivatives; and

xxvii. Wittig, Wittig-Homer reaction including reactions of aldehydes; pheromones and sulfanyl ketones.

In the context of the methods of the present invention, reference may also be made to Patel et al. (1996) who describe the manufacture or synthesis of N-substituted glycines, polycarbamates, mercaptoacylprolines, diketopiperazines, HIV protease inhibitors, 1-3 diols, hydroxystilbenes, B-lactams, 1,4-benzodiazepine-2-5-diones, dihydropyridines and dihydropyrimidines.

In the context of the methods of the present invention, reference may also be made to synthesis of polyketides as discussed, for example, in Rohr (1995).

Chemical or enzymatic synthesis of the compound libraries may also take place on the hybrid polymers of the present invention.

It will also be appreciated that compounds prepared with the hybrid polymers of the present invention may be screened for an activity of interest by methods well known in the art. For example, such screening may be effected by flow cytometry as, for example, described by Needels et al. (1993). Other screening methods that may be used with the present invention include any of the great number of isotopic and non-isotopic labeling and detection methods well-known in the biochemical assay art.

Compounds that may be so screened include, e.g. agonists and antagonists for cell membrane receptors, toxins, venoms, viral epitopes, hormones, sugars, cofactors, peptides, enzyme substrates, drugs inclusive of opiates and steroids, proteins including antibodies, monoclonal antibodies, antisera reactive with specific antigenic determinants, nucleic acids, lectins, polysaccharides, cellular membranes and organelles.

In addition, the present invention may be employed with any of the nucleic acid polymer based hybridization assays well known in the art, including e.g. genotyping, polymorphism detection, gene expression analysis, fingerprinting, and other methods of DNA- or RNA-based sample analysis or diagnosis.

Various aspects of the present invention may be conducted in an automated or semi-automated manner, generally with the assistance of well-known data processing methods. Computer programs and other data processing methods well known in the art may be used to store information of preferred polymer characteristics for use as either substrate polymers and/or polymers to be grafted to a substrate polymer. Data processing methods well known in the art may be used to read input data covering the desired characteristics.

Alternatively, or in addition, data processing methods well known in the art may be used to control the processes involved in the present invention, including e.g. the application of physical stress involved in the grafting process, and/or the polymerization process, and/or the reactions and interactions occurring in, within or between a population or array of polymers grafted to a substrate polymer.

The present invention is further described by the following non-limiting Examples.

### EXAMPLE 1

### General Methods

General Grafting Methods

Moulded plastic samples were placed into the desired solvent, which comprised a solvent and/or a mixture of monomer(s) as described in the examples below. Unless otherwise stated, the conditions of grafting were a solvent which comprised 30% styrene. Furthermore, the monomers were employed as received, without further purification, unless otherwise stated. The solution comprising the moulded plastic, solvent and or monomer, was then degassed sufficiently to allow free radical polymerization by sparging with nitrogen gas, and was subsequently sealed. Unless otherwise stated, grafting was effected by exposing the samples to a dose of γ-irradiation in the range 7-12 kGy. The grafted samples was then washed extensively with a suitable solvent to remove absorbed homopolymer and dried to constant weight.

General Staining Methods

For grafted polymers comprising a styryl unit, staining was effected by aminomethylation, followed by development in a THF solution containing 0.1% bromophenol blue. For aminomethylation, the method based on N-(Hydroxymethyl)phthalimide in the presence of an acid catalyst, methane sulfonic acid in a dry DCM solution containing 20% TFA was used. The free amine was then liberated by treatment with a methanolic solution hydrazine hydrate.

Characterization and Analysis

Raman spectroscopy (mapping step: 2 μm across whole section of the sample) and SEM (magnification 500 times or bigger) was employed in the analysis of these plastic samples.

### EXAMPLE 2

### Generation of a Co-continuous Substrate Polymers from Blended Polypropylenes

(A) Polypropylene EPDM Blend

The following is an example of “Generation and Modification”. Generation of the initial co-continuous phase is performed by washing out a component, which is then followed by the modification of the co-continuous system with monomers (mono and di-functional).

Substrate Polymer Characteristics of Polypropylene EPDM Blend

These thermoplastic polymers have a range of hardness values from about Hardness Shore “A” 35 to Hardness Shore “D” 50 with the ratio of EPDM rubber to polypropylene determining the hardness. They are mouldable, extrudable or thermoformed into desired shape. They show brittle point well below -60° C. Modulus values are 1 to 10 MPa at 25° C. Tensile Strength from 2.0 to 28 Mpa at 25° C. The rubbery part of the polymers can be partially or completely cross-linked. Examples of such substrate polymers are commercially available under the trade name “Santoprene”, by Exxon.

1. Solvent Mediated Co-Continuous Substrate Polymer Fabrication

A plastic sample, which has the substrate polymer characteristics described above, was placed in the selected solvent and left at room temperature for up to 21 hours with agitation. After the desired period of time the plastic sample was isolated and dried to afford a substrate polymer with a reduced weight as a consequence of the solvent extracting a percentage of the soluble component. Furthermore, linked pores in the range from 500-10000 Å (via SEM) were observed. Results for different selected solvents are described below in Table 1.

TABLE 1
Solvent Mediated Co-Continuous Substrate Polymer Fabrication

| | | | Gravimetric Weight |
|---|---|---|---|
| Sample | Solvent | Soaking Time | Differential |
| SR203-40 | Cyclohexane | 21 hours | −27% |
| SR203-40 | n-Hexane | 21 hours | −27% |
| SR8211-65 | Toluene | 21 hours | −45% |
| SR8511-65 | n-Hexane | 21 hours | −43% |

Reduction in gravimetric weight indicates the removal of a soluble component from the substrate polymer to render it co-continuous.

2. Generation of a Hybrid Polymer by Grafting in a Single Solvent

A plastic sample, which has the substrate polymer characteristics described above under Substrate Polymer Characteristics, was placed in a single solvent and left at room temperature for up to 6 hours, with agitation. After the desired period of time, monomer (styrene (Sty) / divinylbenzene (DVB) in 27.8%:2.8% by volume) was added to the solution to afford a 30% monomer solution in the solvent. The mixture was allowed to soak for a further period of time with agitation, prior to being exposed to the standard grafting conditions outlined in Example 1 above. Outcomes of grafting in a single solvent are described below in Table 2.

TABLE 2
Grafting in a Single Solvent

| | | | Gravimetric Weight |
|---|---|---|---|
| Sample | Solvent | Soaking Time | Differential |
| SR8211-65 | MeOH | 14 hours | +43% |
| SR8211-65 | i-PrOH | 18 hours | +19% |
| SR203-40 | MeOH | 14 hours | +44% |
| SR203-40 | i-PrOH | 18 hours | +28% |

Analysis of a section of the grafted samples by Raman and scanning electron microscopy revealed that a co-continuous topology, which was not observed in the ungrafted control, was now present.

3. Generation of a Hybrid Polymer by Grafting in a Mixed Solvent

A plastic sample, which has the substrate characteristics described above under Substrate Polymer Characteristics, was placed in a mixed solvent and left at room temperature for 16 hours with agitation. After the desired period of time, styrene monomer was added to the solution and the mixture allowed to stand for a further 18 hours with agitation, prior to being exposed to the standard grafting conditions outlined above in Example 1. Outcomes are described below in Table 3.

TABLE 3
Grafting in a Mixed Solvent

| | | | Gravimetric |
|---|---|---|---|
| | Solvent | Monomer | Weight |
| Sample | Composition | Concentration | Differential |
| SP8211-65 | Carbon | 30% Solution of | 3% |
| | Tetrachloride (60%) | Styrene (27.8%) & | |
| | Isopropanol (40%) | Divinyl | |
| | | Benzene (2.8%) | |
| SP8211-65 | Carbon | 30% Solution of | 7% |
| | Tetrachloride (20%) | Styrene (27.8%) & | |
| | Isopropanol (80%) | Divinyl | |
| | | Benzene (2.8%) | |
| SP8211-35 | Carbon | 30% Solution of | 5% |
| | Tetrachloride (60%) | Styrene (29%) & | |
| | Methanol (40%) | Divinyl Benzene | |
| | | (1.4%) | |

4. Generation of Co-continuous Hybrid Polymers by Ambient Solvent Mediated Thermal Grafting

A plastic sample, which has the substrate polymer characteristics described above under Substrate Polymer Characteristics, was placed in a washing solvent and left at ambient temperature for 4 hours with agitation. After the desired period of time, the sample was isolated from the solution and dried under vacuum for 16 hours. The dried samples were then exposed to gamma irradiation in air, such that the samples experienced a dose in the range of 100-140 kGy, prior to being placed into the selected monomer solution. The mixture was left at room temperature for up to 4 hours, sparged with nitrogen (that is, nitrogen was bubbled through the solution to degas the solution) prior to being placed in a water bath set at 60° C. for 20 hours. Outcomes for the thermal grafting of ambient solvent mediated co-continuous systems are described below in Table 4.

TABLE 4
Thermal grafting of Ambient Solvent Mediated Co-Continuous
Systems

| | | | Gravimetric |
|---|---|---|---|
| | Washing Sol- | Monomer | Weight |
| Sample | vent & Time | Concentration | Differential |
| SR8211-65 | Toluene, 4 hours | Styrene (100%) | +25% |
| SR203-40 | Toluene, 4 hours | Styrene (100%) | +28% |
| SR203-40 | Toluene, 4 hours | Styrene/DVB (70/30) | +41% |
| SR203-50 | Toluene, 4 hours | Styrene/DVB (70/30) | +17% |

Analysis of a section of the grafted samples by Raman and scanning electron microscopy revealed that a co-continuous topology, which was not observed in the ungrafted control, was now present.

5. Generation of Co-continuous Polymers by Heated Solvent Mediated Thermal Grafting

A plastic sample, which had the substrate characteristics described above under Substrate Polymer Characteristics, was extracted under soxhlet conditions for up to 20 hours. After the desired period of time, the sample was isolated, dried under vacuum for 16 hours and then exposed to γ-irradiation in air, such that the samples experienced a dose in the range of 20-40 kGy, prior to being placed into a solution comprising styrene/divinyl benzene monomer and a single solvent. The cocktail was agitated at room temperature for up to 3 hours, sparged with nitrogen prior to being placed in a water bath set at 60° C. for 17 hours. The outcomes of thermal grafting of heated solvent mediated co-continuous polymer systems are described below in Table 5.

TABLE 5
Thermal grafting of Heated Solvent Mediated Co-Continuous Systems

| | | Grafting Solvent | |
|---|---|---|---|
| | Soxhlet Solvent | and Monomer | Gravimetric |
| Sample | and Time | Concentration | Weight Differential |
| SR-8211-65 | Toluene | PEG 400 (66.7%) | +17.4% |
| | (20 hours) | Styrene (20%) | |
| | | DVB (13.3%) | |
| SR-8211-35 | THF | PEG 900 (60%) | +317% |
| | (17 hours) | Styrene (40%) | |
| | | DVB (0%) | |

SEM indicates a co-continuous “popcorn” type topology with pore sizes in the region of 1 micron. Raman spectroscopy also indicated a distribution of polystyrene throughout the grafted sample.

(B) Polypropylene and Vinyl Polymer Blends

Substrate Polymer Characteristics of the Polypropylene Polymers

These polymers have Hardness Shore “D” of not less than about 60, preferably 60-68; Flexural Modulus values of 800-1200 Mpa; Impact Strength values of 5-12 KJ/m² at 23° C., and a Melt Flow Index not less than about 1 and preferably 3-30. The polymers are injection moulded or extruded using set parameters suitable to generate a crystallinity level of 20-50%. An example of such a polymer is commercially available under the trade name “PMA6100”, by Montell.

1. Incompatible Blend-Mediated Co-continuous Substrate Polymer System Fabrication

The Polypropylene (PP)/Polystyrene (PS) blends were prepared using a Japan Steel Works (JSW) 30 mm twin screw extruder having a length to diameter ratio of 42:1. The JSW30 was operated in the co-rotational mode, the screw profile used for the blending experiments being typical of those used in the polymer industry for preparing blends and filled compounds. The JSW 30 was operated in stave fed mode and the polymers were introduced into the feed throat of the extruder using gravimetric feeders.

The particular grades of both the PP and PS were chosen so as to give materials with a co-continuous morphology over a wide range of compositions. The PS component of the blend was varied from 20 to 70 wt %, with the balance comprising PP. A 200 mm wide EDI Ultraflex L40 flexible lip sheet die was fitted to the JSW 30 to enable the direct production of sheet samples. The die gap was set at 1.0 mm using feeler gauges; this resulted in production of sheets having a nominal thickness of 0.8 mm. The sheet die was configured so as to extrude the polymer downwards. A Brabender three roll stack was used to cool the polymer. The temperature of the water used to chill the rolls used was 48° C.

Alternatively, the extruded material was pelletized. The pellet form of the blended polymers was then introduced into an injection moulding device, to afford 0.35 mm thick, 4 mm diameter discs.

Alternatively, the pelletized form of the blended polymers was then introduced into an injection moulding device, to afford an open-ended cylinder having the following dimensions: length 6 mm; diameter 2.5 mm; wall thickness 0.5 mm.

Polystyrene may be substituted by other incompatibility polymers, such as polyvinyl alcohol and ethylene vinylacetate (EVA). Further, additives may be added to enhance blending outcome required, as for example was carried out with the addition of Styrene Ethylene Butene Styrene (SEBS) to the polypropylene/polystyrene blends.

2. Solvent Mediated Co-Continuous Substrate Polymer Fabrication

From Extruded Sheets

Extruded sheets of polypropylene/polystyrene blend were cut into 1 cm2 pieces, and extracted thoroughly with dichloromethane for 24 hours to remove the polystyrene component of the blended material. Examination of the resulting polymer by Raman spectroscopy and optical and scanning electron microscopy revealed that the polypropylene sample comprised large pores over its surface.

From Injection Moulded Discs

Two different methods were used:

1) Injection moulded discs comprising polypropylene/polystyrene blend were extracted thoroughly with dichloromethane for 24 hours to remove the polystyrene component of the blended material. Examination of the resulting polymer by Raman spectroscopy and optical and scanning electron microscopy revealed that the polypropylene samples comprised large pores over its surface.

2) Injection moulded discs comprising of polypropylene/polyethylene vinyl alcohol blend were extracted thoroughly with dichloromethane for 24 hours to remove the polyethylene vinyl alcohol component of the blended material. Examination of the resulting polymer by Raman spectroscopy and optical and scanning electron microscopy revealed that the polypropylene samples comprised large pores over its surface.

From Injection Moulded Cylinders

Injection moulded cylinders comprising sheets of polypropylene/polystyrene blend were extracted thoroughly with dichloromethane for 24 hours to remove the polystyrene component of the blended material. Examination of the resulting polymer by Raman spectroscopy and optical and scanning electron microscopy revealed that the polypropylene sample comprised large pores over its surface.

3. Generation of Hybrid Polymers by Grafting in a Single Solvent

From Extruded Sheets of Polypropylene/Polystyrene Blend

The extracted, macroporous sheets were exposed to the grafting method outlined above in Example 1, to afford grafted porous hybrid polymeric systems, as outlined below in Table 6.

TABLE 6
Grafting of Extruded Sheets of Polypropylene/Polystyrene Blend in a
Single Solvent

| Polystyrene | Grafting Solvent & | Gravimetric |
|---|---|---|
| content of | Monomer | Weight Differential |
| Blend | Concentration | after Grafting |
| 20% | Methanol, with Styrene (10%) | 4% |
| 25% | Methanol, with Styrene (10%) | 6.4% |
| 40% | Methanol, with Styrene (10%) | 20% |

From Injection Moulded Discs of Polypropylene/Polystyrene Blend

The extracted, macroporous discs were exposed to the grafting method outlined above in Example 1, to afford grafted porous hybrid polymeric systems, as outlined below in Table 7.

TABLE 7
Grafting of Injection Moulded Discs of Polypropylene/Polystyrene
Blend in a Single Solvent

| Polystyrene | Grafting Solvent & | Gravimetric Weight |
|---|---|---|
| Content of | Monomer | Differential after |
| Blend | Concentration | Grafting |
| 30% | Methanol, with Styrene (10%) | 14% |
| 40% | Methanol, with Styrene (10%) | 16% |

From Injection Moulded Cylinders of Polypropylene/Polystyrene Blend

The extracted, macroporous cylinders were exposed to the grafting method outlined above in Example 1, to afford grafted porous hybrid polymeric systems, as outlined below in Table 8.

TABLE 8
Grafting of Injection Moulded Cylinders of Polypropylene/Polystyrene
Blend in a Single Solvent

| | Grafting Solvent & | Gravimetric |
|---|---|---|
| Polystyrene | Monomer | Weight Differential |
| Content | Concentration | after Grafting |
| 40% | Methanol, with Styrene (10%) | 15% |
| 60% | Methanol, with Styrene (10%) | 26% |

From Injection Moulded Discs of Polypropylene/Polyethylene Vinyl Alcohol Blend

The extracted, macroporous discs were exposed to the grafting method outlined above in Example 1, to afford grafted porous hybrid polymeric systems, as outlined below in Table 9.

TABLE 9
Grafting of Injection Moulded Discs of Polypropylene/Polyethylene
Vinyl Alcohol Blend in a Single Solvent

| | EVA | Grafting Solvent & | Gravimetric |
|---|---|---|---|
| Brand of | Content | Monomer | Weight Differen- |
| EVA | of Blend | Concentration | tial after Grafting |
| Escorene | 50% | Methanol, with Styrene (5%) | 6% |
| Escorene | 40% | Methanol, with Styrene (5%) | 3% |
| Elvax | 50% | Methanol, with Styrene (5%) | 15% |
| 40 W | | | |

### EXAMPLE 3

### Generation of a Co-continuous Hybrid Polymer Using a Flexible Polypropylene Copolymer as a Substrate Polymer

The following is an example of “Generation and Modification” of a co-continuous hybrid polymer in one step. Generation of the initial co-continuous phase is performed by swelling the polymer in a suitable solvent, which comprises the desired grafting monomer. The solvent may optionally be a mixture of two or more solvents. This co-continuous system is then modified by in situ grafting (either thermally- or gamma-induced) to afford a swollen hybrid polymer matrix comprising two or more macromolecular types.

Substrate Polymer Characteristics of Flexible Polypropylene Copolymers

These materials are flexible, tough and cold resistant with a MFI of 8-9, specific gravity 0.89 g/cm³, haze 13%, shore hardness in the vicinity of 30 D and Flexural Modulus values of 100-500 MPa. Furthermore, the samples show average resistance to solvents. Examples of such substrate polymers are commercially available, under the trade name “Adeflex”, from Montell.

1. Co-continuous Hybrid Polymer Generation by Single Solvent Induced Grafting

Samples of plastic, which have the substrate polymer characteristics described above were initially swelled in a single solvent for up to 27 hours at room temperature. Styrene monomer was then added and the solution was left at room temperature for up to 18 hours, as outlined in Table 10, prior to being exposed to standard grafting conditions, as described in Example 1 above.

TABLE 10
Solvent Induced Co-Continuous Hybrid Polymer Systems

| | | | Gravimetric |
|---|---|---|---|
| | Solvent and | Monomer Concentration and | Weight |
| Sample | Swelling time | incubation time | Differential |
| Adeflex | n-Hexane | Styrene (16%), DVB (11%), | +18% |
| 100 G | (2.3 hours) | solvent (73%) for 18 hours | |
| Adeflex | i-PrOH | Styrene (29%), DVB (1.4%), | +58% |
| 100 G | (27 hours) | solvent (69.6%) for 18 hours | |

Analysis of a section of the grafted samples by raman and scanning electron microscopy revealed that a co-continuous topology, which was not observed in the ungrafted control, was now present.

2. Co-continuous Hybrid Polymer Generation by Mixed Solvent Induced Grafting

Samples of plastics, which have the substrate polymer characteristics described above, were initially swelled in a mixture of solvent for up to 29 hours at room temperature. Styrene monomer was then added and the solution was left at room temperature for up to 16 hours, prior to being exposed to standard grafting conditions, as described in Example 1 above and outlined in Table 11, below.

TABLE 11
Mixed Solvent Induced Co-Continuous Grafting

| | | Monomer | |
|---|---|---|---|
| | Solvent | Concentration | Gravimetric |
| | Composition & | and Soaking | Weight |
| Sample | Swelling Time | Time | Differential |
| Adeflex | Dichloromethane: | Styrene (29%), | +3% |
| 100 G | Methanol* | DVB (1.4%), | |
| | (10/2) | solvent (69.6%) | |
| | For 29 hours | For 15 hours | |
| Adeflex | Acetone: | Styrene (29%), | +10% |
| 100 G | Methanol* | DVB (1.4%), | |
| | (10/2) | solvent (69.6%) | |
| | For 29 hours | For 15 hours | |
| Adeflex | n-Hexane/ | Styrene (16%), | +41% |
| 100 G | Ethanol | DVB (11%), | |
| | (12/2) | solvent (73%) | |
| | for 2.3 hours | for 18 hours | |
| Adeflex | n-Hexane/ | Styrene (16%), | +75% |
| 100 G | Ethanol | DVB (11%), | |
| | (2/12) | solvent (73%) | |
| | for 2.3 hours | for 18 hours | |
| Adeflex | Tetrahydrofuran/ | Styrene (29%), | +8% |
| 500 G | Methanol* | DVB (1.4%), | |
| | (10/2) | solvent (69.6%) | |
| | for 27 hours | for 15 hours | |
| Adeflex | n-Hexane/ | Styrene (29%), | +9% |
| 500 G | Methanol* | DVB (1.4%), | |
| | (10/2) | solvent (69.6%) | |
| | for 27 hours | for 15 hours | |
| Adeflex | Acetone/ | Styrene (29%), | +9% |
| 500 G | Methanol* | DVB (1.4%), | |
| | (10/2) | solvent (69.6%) | |
| | for 27 hours | for 15 hours | |
| Adeflex | n-Hexane/ | Styrene (16%), | +54% |
| 500 G | Ethanol | DVB (11%), | |
| | (12/2) | solvent (73%) | |
| | for 2.3 hours | for 18 hours | |
| Adeflex | n-Hexane/ | Styrene (16%), | 32% |
| 500 G | Ethanol | DVB (11%), | |
| | (2/12) | solvent (73%) | |
| | for 2.3 hours | for 18 hours | |

*Methanol was added at the same time as monomer.

3. Co-Continuous Hybrid Polymer Generation by Monomer and Single Solvent Induced Grafting

Samples of plastics which have the substrate polymer characteristics described above were initially swelled in a single solvent and styrene monomer for up to 12 hours at room temperature, prior to being exposed to standard grafting conditions described in Example 1 above, as set forth in Table 12, below.

TABLE 12
Monomer and Single Solvent Induced Grafting

| | | Grafting | |
|---|---|---|---|
| | | Solvent and | Gravimetric |
| | Solvent | Monomer | Weight |
| Sample | Time | Concentration | Differencial |
| Adeflex | 30 minutes | Styrene (20%), | +22% |
| 100 G | | Methanol (80%) | |
| Adeflex | 30 minutes | Styrene (40%), | 46% |
| 100 G | | Methanol (60%) | |
| Adeflex | 30 minutes | Styrene (20%), | 7% |
| 500 G | | Methanol (80%) | |
| Adeflex | 30 minutes | Styrene (40%), | +21% |
| 500 G | | Methanol (60%) | |
| Adeflex | 20 hours | Styrene (60%), | +21% |
| 100 G | | Divinyl | |
| | | Benzene (40%) | |
| | | then placed into | |
| | | 100% Methanol | |
| Adeflex | 20 hours | Styrene (60%), | +13% |
| 500 G | | Divinyl | |
| | | Benzene (40%) | |
| | | then placed into | |
| | | 100% Methanol | |

4. Co-Continuous Hybrid Polymer Generation by Monomer and Mixed Solvent Induced Grafting

Samples of plastics which have the substrate polymer characteristics described above were initially swelled in a mixture of solvents and styrene monomer for up to 12 hours at room temperature, prior to being exposed to standard grafting conditions as described above in Example 1. Details are presented in Table 13, below.

TABLE 13
Monomer and Mixed Solvent Induced Co-Continuous Grafting

| | | Grafting Solvent and | Gravimetric |
|---|---|---|---|
| | Soaking | Monomer | Weight |
| Sample | Time | Concentration | Differential |
| Adeflex | 30 minutes | Styrene (33%), | +80% |
| 100 G | | Ethylene Glycol (13.3%), | |
| | | Polyethylene | |
| | | Glycol 400 (53.7%) | |
| Adeflex | 30 minutes | Styrene (20%), Divinyl | +32% |
| 100 G | | Benzene (13.3%), | |
| | | Ethylene Glycol (13.3%), | |
| | | Polyethylene | |
| | | Glycol 400 (53.7%) | |
| Adeflex | 30 minutes | Styrene (30%), Divinyl | +90% |
| 100 G | | Benzene (20%), | |
| | | Ethylene Glycol (12.5%), | |
| | | Polyethylene | |
| | | Glycol 400 (37.5%) | |

5. Thermal grafting of Solvent Induced Co-Continuous Substrate Polymer Systems in Pure Monomer

A plastic sample, of the substrate polymer characteristics described above, was swelled in a single solvent and left at room temperature for up to 4 hours with agitation. After the desired period of time, the sample was isolated from the solvent and dried under vacuum for 24 hours. The dried samples were then exposed to gamma irradiation, in air such that the samples experienced a dose in the range of 100-140 kGy, prior to being placed in monomer. The cocktail was left at room temperature for up to 6 hours, sparged with nitrogen prior to being placed in a water bath set at 60° C. for 60 hours. Outcomes are described in Table 14, below.

TABLE 14
Thermal grafting of Solvent Induced Co-Continuous Systems

| | | | Gravimetric |
|---|---|---|---|
| | Swelling Solvent & | Grafting Solvent & | Weight |
| Sample | Time | Monomer Concentration | Differential |
| 100 G | n-Hexane | Styrene (100%) | +115% |
| | (4 hours) | | |
| 100 G | Toluene | Styrene (100%) | +80% |
| | (4 hours) | | |

SEM indicated nodules of polystyrene throughout the cross-section of the samples. Further, such topology was not present in the non-graft control.

### EXAMPLE 4

### Generating Co-continuous Surfaces on Substrate Polymers for Subsequent Grafting

The following are examples of “Generation”, to afford a co-continuous polymer layer on top of a rigid basement substrate. The substrate may optionally be susceptible to grafting, or may be activated to accept the co-continuous coating. The nature of the substrate may be selected from a range of plastics, and not limited by polypropylene or fluoropolymer. The co-continuous layer is generated from known-in-the-art formulations that include porogenic components, such as water.

Further, the co-continuous layer is applied to the substrate as a uniform coating to afford a hydrid polymer that has a uniform co-continuous layer over the whole of the substrate, or in discrete regions of the substrate to afford a hydrid polymer that has discrete zones of co-continuous layers over the entire substrate at a predetermined position and density. The following examples (A-D) describe uniform co-continuous layers over the whole of the substrate.

(A) Generation of a Rigid Basement Substrate with a Co-continuous Coating #1

1. Preparation of Co-Continuous Formulation

To a mixture of divinyl benzene (5.5 ml of 80% DVB from Aldrich), styrene (4.5 ml) and Sorbitan Monooleate (3 ml) was added slowly over a period of 20 to 30 minutes, 90 ml of a degassed, aqueous solution comprising calcium chloride (1.0 g) and potassium persulfate (0.2 g). During the addition of the aqueous solution, the mixture was stirred with an overhead stirrer, at 300 rpm, affixed with a D shaped paddle. Furthermore, during the process the system was purged with nitrogen. The mixture became white and had the consistency of whipped cream.

2. Activation of the Substrate Polymer

A substrate polypropylene/EPR copolymer with of a Hardness Shore “D” 66, a Flexural Modulus Value of 1050, an Impact Strength Value of 6, a crystallinity level below 65% and a Melt Flow Index of 5.5, was placed into a 80% divinyl benzene methanolic solution and treated under standard grafting conditions, as outlined above in Example 1. Raman spectroscopy of the grafted polymer indicated the presence of residual vinyl groups distributed over the surface of polypropylene copolymer.

3. Grafting Of The Co-Continuous Formulation To The Substrate Polymer

An intimate mixture of the activated substrate polymer, prepared as described above, and the co-continuous formulation, prepared as described above, was prepared in a glass jar. The jar was purged with nitrogen, sealed and heated at 60° C. for 16 hr to afford a cross-linked mass of polymer, from which the grafted polypropylene was isolated. Raman spectroscopy and optical and scanning electron microscopy revealed that the polypropylene sample was comprised of grafted polymer, and that large pores were present over the surface.

(B) Generation of a Rigid Basement Substrate with Co-continuous Coating #2

1. Preparation of Co-continuous Formulation

Part A

The ATRP initiating glucose core, 1,2,3,4,6-penta-O-iso-butyryl bromide-α-D-Glucose was synthesised by slow addition of 2-bromo-iso-butyrylbromide (50 g) to a solution of α-D-Glucose (5 g) in an anhydrous mixture of chloroform (100 ml) and pyridine (50 ml). The mixture was refluxed for 3 hr whilst maintaining a dry atmosphere and then stirred at room temperature for a further 12 hr. The solution was washed with ice-cold water, NaOH (0.1 M) and water respectively. The organic layer was dried over MgSO₄ after which the organic solvent was removed via rotary evaporation. The crude product was recrystallised from methanol to yield the ATRP initiating glucose core as white crystals.

A schlenk flask was charged with predetermined amounts of inhibitor-free styrene monomer (152 ml) ATRP initiating glucose core prepared above (2.59 g), CuBr catalyst (2.03 g), and ligand N-(propyl)-2-pyridyl methanimine (4.367 g). The mixture was immediately degassed by three freeze-pump-thaw cycles and then purged under nitrogen atmosphere. The mixture was polymerized at 90° C. in a thermostated oil bath for appropriate time intervals. After polymerization the removal of the ligand and catalyst was achieved by passing the reaction mixture through a basic alumina oxide column, and the star polymer with polystyrene arms and a glucose core were purified by precipitation into methanol.

The star: polystyrene arms, glucose core prepared above (2 g) was dissolved in 20 ml of dry dimethyl formamide. To the stirred mixture was added 1.26 g of triethylamine and 0.254 g of ethanolamine and stirred for 2 days at 25° C. The afforded OH-terminated star polymer with a glucose core was then purified by repeated precipitation into methanol from dimethyl formamide.

Part B

A mixture of inhibitor-free styrene monomer (20 g), 3-isopropenyl-α,α-dimethyl benzyl isocyanate, (m-TMI (20 g), 1-phenylethyl phenyldithioacetate (40 mg) and AIBN (10 mg) was degassed by nitrogen purging for 30 minutes in a sealed reaction vessel. The mixture was polymerized at 60° C. in a thermostated oil bath for 24 hours. The afforded styrene-co-mTMI was recovered by precipitation into dodecane and drying for 4 days under vacuum at 25° C.

2. Grafting of the Co-Continuous Formulation to the Substrate Polymer

A solution of 360 mg of the OH-terminated star polymer with a glucose core prepared above in Part A and 40 mg of styrene-co-mTMI prepared above in Part B was dissolved in 10 ml of dichloromethane. Two drops of the casting solution were deposited from a pasteur pipette onto the top of the polyproplene porous support in the shape of a disc, such as those supplied under the trade name “POREX”, in a controlled humid atmosphere with a moist air flow. The temperature and relative humidity were 22° C. and 90%, respectively. The cast discs were allowed to dry in the casting apparatus for 5 minutes. The cast discs were then cured in sealed sample vials at 80° C. for 24 hr, 90° C. for a further 24 hr and finally at 95° C. for 24 hr in a temperature-controlled oil bath, to afford the grafted co-continuous system.

(C) Generation of a Rigid Basement Substrate with a Co-continuous Coating #3

1. Preparation of Co-continuous Formulation

A solution of 2,2′-azobisisobutyronitrile (AIBN) 0.12 g, Chloromethylstyrene 4.8 g; Divinyl Benzene 7.2 g, 1-dodecanol 12.75 g, and Polyethylene glycol EG600 5.25 g was combined to afford the co-continuous formulation.

2. Grafting of the Co-Continuous Formulation to the Substrate Polymer

To the co-continuous formation prepared above was added high molecular weight polyethylene porous support in the shape of a disc, such as those supplied under the trade name “POREX”. The supports were incubated in the polymerization solution for 1 hour before retrieving them and placing them into a sealable vial. The vial was then purged with N₂ for 5 minutes to remove oxygen and the coated supports cured by heating the sample at 70° C. for 64 hours. The sample was then washed with THF, DCM and dried under 50° C. vacuum oven, to afford a porous substrate with a co-continuous coating with a grafted mass increase of 57.3%.

Alternatively, substituting toluene for PEG600 afforded a porous substrate with a co-continuous coating with a grafted mass increase of 32.9%. (2LS049-141)

(D) Generation of a Rigid Basement Substrate with a Co-continuous Coating and Subsequent Polymerization from the Co-continuous Substrate

1. Preparation of Co-continuous Formulation

Phenyl magnesium bromide was prepared from bromobenzene (10.0 g, 63 mmol) and magnesium turnings (1.4 g, 58 mmol) in dry tetrahydrofuran (50 ml). The solution was warmed to 40° C. and carbondisulfide (4.5 g, 59 mmol) was added over 15 min whilst maintaining the reaction temperature of 40° C. To the resultant dark brown mixture was added hexakis(bromomethyl)benzene (5.0 g, 47 mmol) over 15 min. The reaction temperature was raised to 50° C. and maintained at that temperature for further 3 hr. Ice water (200 ml) was added and the organic products were extracted with chloroform. The organic phase was washed with water (150 ml) and dried over anhydrous magnesium sulfate. After removal of the solvent, hexakis(thiobenzoyl thiomethyl) benzene was recrystallised from ethanol/chloroform. Hexakis(thiobenzoyl thiomethyl) benzene and styrene monomer were mixed together and degassed by bubbling nitrogen through the solution. The bottles were sealed and brought into an oil or water bath thermostated at 60° C., for 24 hours. The afforded star-like polymer was recovered by precipitation into methanol, to afford a white power of Mn 25662.

2. Grafting of the Co-Continuous Formulation to the Substrate Polymer

A 10 mg/ml solution of polystyrene star polymer prepared above was dissolved in carbon disulphide. This solution was cast onto the surface of a polypropylene disc (ca 5 mm diameter, 1 mm thick) at 20° C. in a controlled humid atmosphere (relative humidity of 90%) with a moist airflow directed over the surface of the disc. Once the macroporous film formation and drying were complete (about 5 minutes), the procedure was repeated on the opposing surface of the polypropylene disc.

3. Grafting from the Co-Continuous Topology on the Substrate Polymer

A bulk polymerization solution containing 0.018 g (0.066 mmol) of cumyl dithiobenzoate, 0.006 g (0.036 mmol) AIBN, 5 g (38.5 mmol) ethyl-α-hydroxymethacrylate and 5 g absolute ethanol was prepared in a 25 ml conical flask. Five macroporous discs prepared above were then added and, after sealing the vials with rubber septa, the solutions were degassed by bubbling with nitrogen gas for 30 minutes. The sample was heated at 60° C. in a temperature-controlled oil bath for 4 days to initiate the RAFT polymerization process both in the supernatant and from the accessible RAFT end groups on the macroporous surface.

After 4 days, the macroporous discs were removed from the polymerization solution and washed repeatedly over three days with absolute ethanol. The macroporous surfaces were then solubilized in deuterated chloroform and THF for NMR and GPC analysis, respectively. Both NMR and GPC revealed the presence of surface-initiated polyethyl-α-hydroxymethacrylate.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

Bibliography

Berg, R. H., Almdal, K., Pederson, W. B., Holm, A., Tam, J. P. and Merrifield, R. B., J. Am. Chem. Soc. 111: 8024-8026, 1989.

Hori, M., Gravert, D. J., Wentworth, P. Jr. and Janda, K. D., Biororganic & Med. Chem. Letters 8:2363-2368, 1998.

Machi, S., Kamel, I. and Silverman, J., J Polymer Science 8: 3329, 3337, 1970.

Maeji, N. J., Valerio, R. M., Bray, A. M., Campbell, R. A. and Geysen, H. M. Reactive Polymers 22:203-212, 1994.

Needels et al., Proc. Natl. Acad. Sci. USA 90:10700-10704, 1993.

Patel et al., DDT 1(4):134-144, 1996

Rohr, Angew. Int. Ed. Engl. 34:881-884, 1995

Schaaper, W. M. M., Beekman, N. J. C. M., Hage, M., Briel, P., Kuperus, D. and Meloen, R. H., in J. A. Smith and J. E. Rivier (Eds.), 12^{th} American peptide Symposium, Boston, Mass., Jun. 16-21, 1991, Escom, Leiden, p. 651, 1992.

Sherrington, D., Chem. Comm. 1-12, 1998.

Tregear, G. W. In Chemistry and Biology of peptides: Meienhofer, J., Ed., Ann Arbor Sci. Publ: Ann Arbor, Mich., pp175-178, 1972.

Widawski et al.,Nature 369:387-389, 1994

Zhao, C., Shi, S., Mir, D., Hurst, D., Li, R., Xiao, X., Lillig, J. and Czarnik, A. W., J. Combinatorial Chemistry 1:91-95, 1999.

1. A substrate polymer comprising a polymer with a surface modified to facilitate co-continuity of functional groups to an external environment.

2. The substrate polymer of claim 1, wherein the polymer comprises a polyolefin, a fluoropolymer or a blend of polymers or co-polymers.

3. The substrate polymer of claim 2, wherein the polymer comprises polypropylene or a polypropylene/EPR co-polymer.

4. The substrate polymer of claim 2, wherein the polymer comprises a polypropylene/EPDM blend.

5. The substrate polymer of claim 2, wherein the polymer comprises polyethylene.

6. The substrate polymer of claim 1, wherein the polymer comprises the following characteristics:
a hardness value of from about Hardness Shore “A” 5 to about Hardness Shore “D” 100; and
a Flexural Modulus Value of from about 50 to about 2000 Mpa.

7. The substrate polymer of claim 1, wherein the polymer comprises a solid phase.

8. The substrate polymer of claim 1, wherein the polymer is prepared by a method of macroporous formulation.

9. The substrate polymer of claim 1, wherein the polymer is macroporous.

10. The substrate polymer of claim 1, wherein the substrate polymer has a mouldable shape.

11. The substrate polymer of claim 10, wherein the shape is a cylinder, film, sheet, bead or disc.

12. The substrate polymer of claim 1, wherein the external environment comprises a liquid, solid or gaseous environment comprising reactive entities.

13. The substrate polymer of claim 12, further comprising one or more polymers or monomeric units thereof grafted to the substrate polymer in pellicular formation.

14. A hybrid polymer comprising a substrate polymer with a surface modified to facilitate co-continuity of functional groups to an external environment and one or a plurality of grafted polymers in pellicular formation, wherein at least one polymer in the hybrid polymer maintains the co-continuous character of functional groups to an external environment.

15. The hybrid polymer of claim 14, wherein the substrate polymer comprises a polyolefin, a fluoropolymer or a blend of polymers or co-polymers.

16. The hybrid polymer of claim 15, wherein the substrate polymer comprises polypropylene or a polypropylene/EPR co-polymer.

17. The hybrid polymer of claim 15, wherein the substrate polymer comprises a polypropylene/EPDM blend.

18. The hybrid polymer of claim 15, wherein the substrate polymer comprises polyethylene.

19. The hybrid polymer of claim 14, wherein the substrate polymer comprises the following characteristics:
a hardness value of from about Hardness Shore “A” 5 to about Hardness Shore “D” 100; and
a Flexural Modulus Value of from about 50 to about 2000 Mpa.

20. The hybrid polymer of claim 14, wherein the substrate polymer is a polyolefin or fluorinated polymer comprising the following characteristics:
a hardness value of from about Hardness Shore “A” 10 to about Hardness Shore “D” 80; and
a Flexural Modulus Value of from about 80 to about 1200 Mpa.

21. The hybrid polymer of claim 14, wherein the substrate polymer comprises a solid phase.

22. The hybrid polymer of claim 14, wherein the substrate polymer is prepared by a method of macroporous formulation.

23. The hybrid polymer of claim 14, wherein the substrate polymer is macroporous.

24. The hybrid polymer of any one of claims 11 to 23, wherein the external environment comprises a liquid, solid or gaseous environment comprising reactive entities.

25. The hybrid polymer of claim 14, wherein the one or a plurality of grafted polymers is macroporous.

26. The hybrid polymer of claim 25, wherein the one or a plurality of grafted polymers comprise one or more olefinically-unsaturated monomers.

27. The hybrid polymer of claim 26, wherein the one or more olefinically-unsaturated monomers are selected from the list comprising methyl methacrylate, ethyl methacrylate, propyl methacrylate including all isomers thereof, butyl methacrylate including all isomers thereof, other alkyl methacrylates, corresponding acrylates, functionalized methacrylates and acrylates fluoroalkyl (meth)acrylates, methacrylic acid, acrylic acid, fumaric acid and esters thereof, itaconic acid and esters thereof, nucleic anhydride, styrene, .alpha.-methyl styrene, vinyl halides, acrylonitrile, methacrylonitrile, vinylidene halides of formula CH₂—C(Hal)₂ wherein each halogen is independently Cl or F, optionally substituted butadiene of the formula CH₂═C(R₁)C(R₁)═CH₂ wherein R₁ is independently H, Cl to C₁₀ alkyl, Cl or F, sulphonic acids or derivatives thereof of formula CH₂═CHSO₂OM wherein M is NaS, K, Li, N(R₂)₄, or —(CH₂)₂—D wherein each R₂ is independently H or Cl or C₁₀ alkyl, D is CO₂Z, OH, N(R₂)₂ or SO₂OZ and Z is H. Li, Na, K or N(R₂)₄, acrylamide or derivatives thereof of formula CH₂—C(CH₃)CON(R₂)₂, and/or mixtures thereof.

28. The hybrid polymer of claim 27, wherein the one or more olefinically-unsaturated monomers are selected from the list comprising functionalized methacrylates and styrene.

29. The hybrid polymer of any one of claims 25 to 28, wherein the one or a plurality of grafted polymers is prepared by a method of macroporous formulation.

30. The hybrid polymer of claim 29, wherein the grafted polymer comprises a honeycomb-like polymer selected from the list comprising a star polymer, a block polymer and a graft polymer.

31. The hybrid polymer of claim 29, wherein the grafted polymer comprises a polyHIPE-like polymer.

32. The hybrid polymer of claim 29, wherein the grafted polymer is made by a microemulsion polymerization method.

33. The hybrid polymer of claim 14, wherein the hybrid polymer has a mouldable shape.

34. The hybrid polymer of claim 33, wherein the shape is a cylinder, film, sheet, bead or disc.

35. The hybrid polymer of claim 34, wherein the hybrid polymer is useful as a substrate for solid phase applications including subsequent grafting.

36. A process for generating a hybrid polymer with a co-continuous character useful as a substrate for solid phase applications, said process comprising grafting a polymer to a substrate polymer wherein said grafted polymer is sufficiently rigid to permit access of individual functional groups in or within said hybrid polymer to an external environment.

37. The process of claim 36, wherein the substrate polymer comprises a polyolefin, a fluoropolymer or a blend of polymers or co-polymers.

38. The process of claim 36, wherein the substrate polymer comprises polypropylene or a polypropylene/EPR co-polymer.

39. The process of claim 36, wherein the substrate polymer comprises a polypropylene/EPDM blend.

40. The process of claim 36, wherein the substrate polymer comprises polyethylene.

41. The process of claim 36, wherein the substrate polymer comprises the following characteristics:
a hardness value of from about Hardness Shore “A” 5 to about Hardness Shore “D” 100; and
a Flexural Modulus Value of from about 50 to about 2000 Mpa.

42. The process of claim 36, wherein the substrate polymer is a polyolefin or fluorinated polymer comprising the following characteristics:
a hardness value of from about Hardness Shore “A” 10 to about Hardness Shore “D” 80; and
a Flexural Modulus Value of from about 80 to about 1200 Mpa.

43. The process of claim 36, wherein the substrate polymer comprises a solid phase.

44. The process of claim 36, wherein the substrate polymer is prepared by a method of macroporous formulation.

45. The process of claim 36, wherein the substrate polymer is macroporous.

46. The process of claim 36, wherein one or more polymers or monomeric units thereof are grafted to the substrate polymer in pellicular formation.

47. The process of claim 36, wherein the grafted polymer is macroporous.

48. The process of claim 47, wherein the macroporous grafted polymer comprises one or more olefinically-unsaturated monomers.

49. The process of claim 47, wherein said one or more olefinically-unsaturated monomers are selected from the list comprising methyl methacrylate, ethyl methacrylate, propyl methacrylate including all isomers thereof, butyl methacrylate including all isomers thereof, other alkyl methacrylates, corresponding acrylates, functionalized methacrylates and acrylates fluoroalkyl (meth)acrylates, methacrylic acid, acrylic acid, fumaric acid and esters thereof, itaconic acid and esters thereof, nucleic anhydride, styrene, .alpha.-methyl styrene, vinyl halides, acrylonitrile, methacrylonitrile, vinylidene halides of formula CH₂—C (Hal)₂ wherein each halogen is independently Cl or F, optionally substituted butadiene of the formula CH₂═C(R₁)C(R₁)═CH₂ wherein R₁ is independently H, Cl to C₁₀ alkyl, Cl or F, sulphonic acids or derivatives thereof of formula CH₂═CHSO₂OM wherein M is NaS, K, Li, N(R₂)₄, or —(CH₂)₂—D wherein each R₂ is independently H or Cl or C₁₀ alkyl, D is CO₂Z, OH, N(R₂)₂ or SO₂OZ and Z is H. Li, Na, K or N(R₂)₄, acrylamide or derivatives thereof of formula CH₂—C(CH₃)CON(R₂)₂, and/or mixtures thereof.

50. The process of claim 49, wherein said one or more olefinically-unsaturated monomers are selected from the list comprising functionalized methacrylates and styrene.

51. The process of claim 47 to 50, wherein the grafted polymer is prepared by a method of macroporous formulation.

52. The process of claim 51, wherein the method of macroporous formulation results in a honeycomb-like polymer arrangement selected from the list comprising a star polymer, a block polymer and a graft polymer.

53. The process of claim 51, wherein the macroporous formulation method results in a polyHIPE-type polymer arrangement.

54. The process of claim 51, wherein the macroporous formulation method comprises a microemulsion polymerization method.

55. The process of claim 36, wherein the hybrid polymer has a mouldable shape.

56. The process of claim 55, wherein the shape is a cylinder, film, sheet, bead or disc.

57. The process of claim 36, wherein the hybrid polymer is macroporous.

58. The process of claim 36, wherein the hybrid polymer is used as a substrate for subsequent grafting.

59. The process of claim 58, wherein the subsequent grafting comprises the addition of olefinically-unsaturated monomers.

60. The process of claim 58, wherein the olefinically-unsaturated monomers are selected from the list comprising methyl methacrylate, ethyl methacrylate, propyl methacrylate including all isomers thereof, butyl methacrylate including all isomers thereof, other alkyl methacrylates, corresponding acrylates, functionalized methacrylates and acrylates fluoroalkyl (meth)acrylates, methacrylic acid, acrylic acid, fumaric acid and esters thereof, itaconic acid and esters thereof, nucleic anhydride, styrene, .alpha.-methyl styrene, vinyl halides, acrylonitrile, methacrylonitrile, vinylidene halides of formula CH₂—C (Hal)₂ wherein each halogen is independently Cl or F, optionally substituted butadiene of the formula CH₂═C(R₁)C(R₁)═CH₂ wherein R₁ is independently H, Cl to C₁₀ alkyl, Cl or F, sulphonic acids or derivatives thereof of formula CH₂═CHSO₂OM wherein M is NaS, K, Li, N(R₂)₄, or —(CH₂)₂—D wherein each R₂ is independently H or Cl or C₁₀ alkyl, D is CO₂Z, OH, N(R₂)₂ or SO₂OZ and Z is H. Li, Na, K or N(R₂)₄, acrylamide or derivatives thereof of formula CH₂—C(CH₃)CON(R₂)₂, and/or mixtures thereof.

61. The process of claim 60, wherein the olefinically-unsaturated monomers are selected from the list comprising functionalized methacrylates and styrene.

62. A method for generating a hybrid polymer exhibiting co-continuous character, said method comprising subjecting a substrate polymer to physical stress sufficient to graft one or more other polymers or monomeric subunits thereof and subjecting same to conditions sufficient for said one or more polymers or monomeric subunits thereof to form a thin layer having co-continuous properties.

63. The method of claim 62, wherein the substrate polymer comprises a polyolefin, a fluoropolymer or a blend of polymers or co-polymers.

64. The method of claim 62, wherein the substrate polymer comprises polypropylene or a polypropylene/EPR co-polymer.

65. The method of claim 62, wherein the substrate polymer comprises a polypropylene/EPDM blend.

66. The method of claim 62, wherein the substrate polymer comprises polyethylene.

67. The method of claim 62, wherein the substrate polymer comprises the following characteristics:
a hardness value of from about Hardness Shore “A” 5 to about Hardness Shore “D” 100; and
a Flexural Modulus Value of from about 50 to about 2000 Mpa.

68. The method of claim 62, wherein the substrate polymer is a polyolefin or fluorinated polymer comprising the following characteristics:
a hardness value of from about Hardness Shore “A” 10 to about Hardness Shore “D” 80; and
a Flexural Modulus Value of from about 80 to about 1200 Mpa.

69. The method of claim 62, wherein the substrate polymer comprises a solid phase.

70. The method of claim 62, wherein the substrate polymer is made by a method of macroporous formulation.

71. The method of claim 62, wherein the substrate polymer is macroporous.

72. The method of claim 62, wherein the one or more polymers or monomeric units thereof are grafted to the substrate polymer in pellicular formation.

73. The method of claim 72, wherein grafting occurs under conditions in which two or more polymers or monomeric units thereof associate by chemical bonding.

74. The method of claim 73, wherein the conditions in which two or more polymers associate comprise the formation of radicals to initiate polymerization of monomeric or polymeric units.

75. The method of claim 62, wherein the entire substrate polymer is subjected to physical stress.

76. The method of claim 62, wherein a surface or sub-surface region of the substrate polymer is subjected to physical stress.

77. The method of claim 75 or 76, wherein the physical stress comprises one or more of stretching, twisting, indenting, bending, compressing, scratching, cutting, heating, irradiating or ejection from a mould.

78. The method of claim 62, wherein the grafted polymer is macroporous.

79. The method of claim 78, wherein the macroporous grafted polymer comprises one or more olefinically-unsaturated monomers.

80. The method of claim 79, wherein said one or more olefinically-unsaturated monomers are selected from the list comprising methyl methacrylate, ethyl methacrylate, propyl methacrylate including all isomers thereof, butyl methacrylate including all isomers thereof, other alkyl methacrylates, corresponding acrylates, functionalized methacrylates and acrylates fluoroalkyl (meth)acrylates, methacrylic acid, acrylic acid, fumaric acid and esters thereof, itaconic acid and esters thereof, nucleic anhydride, styrene, .alpha.-methyl styrene, vinyl halides, acrylonitrile, methacrylonitrile, vinylidene halides of formula CH₂—C (Hal)₂ wherein each halogen is independently Cl or F, optionally substituted butadiene of the formula CH₂═C(R₁)C(R₁)═CH₂ wherein R₁ is independently H, Cl to C₁₀ alkyl, Cl or F, sulphonic acids or derivatives thereof of formula CH₂═CHSO₂OM wherein M is NaS, K, Li, N(R₂)₄, or —(CH₂)₂—D wherein each R₂ is independently H or Cl or C₁₀ alkyl, D is CO₂Z, OH, N(R₂)₂ or SO₂OZ and Z is H. Li, Na, K or N(R₂)₄, acrylamide or derivatives thereof of formula CH₂—C(CH₃)CON(R₂)₂, and/or mixtures thereof.

81. The method of claim 80, wherein the olefinically-unsaturated monomers are selected from the list comprising functionalized methacrylates and styrene.

82. The method of claim 78 to 81, wherein the grafted polymer is made by a method of macroporous formulation.

83. The method of claim 82, wherein the method of macroporous formulation results in a honeycomb-like polymer arrangement selected from the list comprising a star polymer, a block polymer and a graft polymer.

84. The method of claim 82, wherein the means results in a polyHIPE-like polymer arrangement.

85. The method of claim 82, wherein the method of macroporous formulation is a microemulsion polymerization

86. The method of claim 62, wherein said conditions sufficient to form a thin layer comprise exposure to a temperature between −20° C. and 200° C. and exposure to an energy source selected from the list comprising γ-radiation, electron beam radiation, atomic particles, X-rays, U.V., visible or I.R. radiation.

87. The method of claim 62, wherein said conditions sufficient to form a thin layer include exposure to a solvent selected from the list comprising a protic solvent and a non-protic solvent.

88. The method of claim 87, wherein the protic solvent is water or water vapour.

89. The method of claim 62, wherein said one or more other polymers or monomeric subunits thereof is grafted to the substrate polymer in pellicular formation.

90. The method of claim 62, wherein the hybrid polymer has a mouldable shape.

91. The method of claim 90, wherein the shape is a cylinder, film, sheet, bead or disc.

92. The method of claim 91, wherein the hybrid polymer is used as a substrate for subsequent grafting.

93. The method of claim 92, wherein the subsequent grafting comprises the addition of one or more olefinically-unsaturated monomers.

94. The method of claim 93, wherein said one or more olefinically-unsaturated monomers are selected from the list comprising methyl methacrylate, ethyl methacrylate, propyl methacrylate including all isomers thereof, butyl methacrylate including all isomers thereof, other alkyl methacrylates, corresponding acrylates, functionalized methacrylates and acrylates fluoroalkyl (meth)acrylates, methacrylic acid, acrylic acid, fumaric acid and esters thereof, itaconic acid and esters thereof, nucleic anhydride, styrene, .alpha.-methyl styrene, vinyl halides, acrylonitrile, methacrylonitrile, vinylidene halides of formula CH₂—C (Hal)₂ wherein each halogen is independently Cl or F, optionally substituted butadiene of the formula CH₂═C(R₁)C(R₁)═CH₂ wherein R₁ is independently H, Cl to C₁₀ alkyl, Cl or F, sulphonic acids or derivatives thereof of formula CH₂═CHSO₂OM wherein M is NaS, K, Li, N(R₂)₄, or —(CH₂)₂—D wherein each R₂ is independently H or Cl or C₁₀ alkyl, D is CO₂Z, OH, N(R₂)₂ or SO₂OZ and Z is H. Li, Na, K or N(R₂)₄, acrylamide or derivatives thereof of formula CH₂—C(CH₃)CON(R₂)₂, and/or mixtures thereof.

95. The method of claim 94, wherein said one or more olefinically-unsaturated monomers are selected from the list comprising functionalized methacrylates and styrene.

96. A method for generating a hybrid polymer comprising a substrate polymer and a second or optionally further polymers grafted to a surface and/or sub-surface regions of said substrate polymer optionally in an array, said method comprising:
subjecting said substrate polymer or surface and sub-surface regions thereof to sufficient physical stress to enable the substrate polymer or its regions to form a hybrid with said second or optionally further polymers or monomeric units thereof,
contacting said treated substrate polymer with said second or optionally further polymers under conditions sufficient for the second or optionally further polymers to graft to said substrate polymer or regions thereof;
whereby said second or optionally further polymers is grafted to the surface and/or sub-surface regions of said substrate polymer wherein at least one polymer in the hybrid polymer maintains the co-continuous character of functional groups of said polymer to an external environment.

97. The method of claim 96, wherein the substrate polymer comprises a polyolefin, a fluoropolymer or a blend of polymers or co-polymers.

98. The method of claim 96, wherein the substrate polymer comprises polypropylene or a polypropylene/EPR co-polymer.

99. The method of claim 96, wherein the substrate polymer comprises a polypropylene/EPDM blend.

100. The method of claim 96, wherein the substrate polymer comprises polyethylene.

101. The method of claim 96, wherein the substrate polymer comprises the following characteristics:
a hardness value of from about Hardness Shore “A” 5 to about Hardness Shore “D” 100; and
a Flexural Modulus Value of from about 50 to about 2000 Mpa.

102. The method of claim 96, wherein the substrate polymer is a polyolefin or fluorinated polymer comprising the following characteristics:
a hardness value of from about Hardness Shore “A” 10 to about Hardness Shore “D” 80; and
a Flexural Modulus Value of from about 80 to about 1200 Mpa.

103. The method of claims 96, wherein the substrate polymer comprises a solid phase.

104. The method of claim 96, wherein the substrate polymer is made by a method of macroporous formulation.

105. The method of claim 96, wherein the substrate polymer is macroporous.

106. The method of claim 96, wherein one or more polymers or monomeric units thereof are grafted to the substrate polymer or surface or sub-surface regions thereof in pellicular formation.

107. The method of claim 106, wherein grafting occurs under conditions in which two or more polymers or monomeric units thereof associate by chemical bonding.

108. The method of claim 107, wherein the conditions in which two or more polymers associate comprise the formation of radicals to initiate polymerization of monomeric or polymeric units.

109. The method of claim 96, wherein the entire substrate polymer is subjected to physical stress.

110. The method of claim 96, wherein a surface or sub-surface region of the substrate polymer is subjected to physical stress.

111. The method of claims 109 or 110, wherein the physical stress comprises one or more of stretching, twisting, indenting, bending, compressing, scratching, cutting, heating irradiating, or ejection from a mould.

112. The method of claim 96, wherein the grafted polymer is macroporous.

113. The method of claim 112, wherein the grafted macroporous polymer comprises one or more olefinically-unsaturated monomers.

114. The method of claim 113, wherein said one or more olefinically-unsaturated monomers are selected from the list comprising methyl methacrylate, ethyl methacrylate, propyl methacrylate including all isomers thereof, butyl methacrylate including all isomers thereof, other alkyl methacrylates, corresponding acrylates, functionalized methacrylates and acrylates fluoroalkyl (meth)acrylates, methacrylic acid, acrylic acid, fumaric acid and esters thereof, itaconic acid and esters thereof, nucleic anhydride, styrene, .alpha.-methyl styrene, vinyl halides, acrylonitrile, methacrylonitrile, vinylidene halides of formula CH₂—C (Hal)₂ wherein each halogen is independently Cl or F, optionally substituted butadiene of the formula CH₂═C(R₁)C(R₁)═CH₂ wherein R₁ is independently H, Cl to C₁₀ alkyl, Cl or F, sulphonic acids or derivatives thereof of formula CH₂═CHSO₂OM wherein M is NaS, K, Li, N(R₂)₄, or —(CH₂)₂—D wherein each R₂ is independently H or Cl or C₁₀ alkyl, D is CO₂Z, OH, N(R₂)₂ or SO₂OZ and Z is H. Li, Na, K or N(R₂)₄, acrylamide or derivatives thereof of formula CH₂—C(CH₃)CON(R₂)₂, and/or mixtures thereof.

115. The method of claim 114, wherein said one or more olefinically-unsaturated monomers are selected from the list comprising functionalized methacrylates and styrene.

116. The method of claim 112 to 115, wherein the grafted polymer is made by a method of macroporous formulation.

117. The method of claim 116, wherein the method of macroporous formulation results in a honeycomb-like polymer arrangement selected from the list comprising a star polymer, a block polymer and a graft polymer.

118. The method of claim 116, wherein the means results in a polyHIPE-like polymer arrangement.

119. The method of claim 116, wherein the method of macroporous formulation is a microemulsion polymerization.

120. The method of claim 96, wherein said conditions sufficient for the second or optionally further polymers or monomeric units thereof to graft comprise exposure to a temperature between −50° C. and 150° C. and exposure to an energy source selected from the list comprising γ-radiation, electron beam radiation, atomic particles, X-rays, U.V., visible or I.R. radiation.

121. The method of claim 96, wherein said conditions sufficient for the second or optionally further polymers or monomeric units thereof to graft comprise exposure to a solvent selected from the list comprising a protic solvent or a non-protic solvent.

122. The method of claim 120, wherein the protic solvent is water or water vapour.

123. The method of claim 96, said second or optionally further polymers or monomeric units thereof is grafted to the substrate polymer in pellicular formation.

124. The method of claim 96, wherein the external environment comprises a surrounding solvent, solution or other liquid, solid or gaseous environment comprising reactive entities.

125. The method of claim 96, wherein the array comprises an ordered pattern of regions on the surface or sub-surface of the substrate polymer.

126. The method of claim 96, wherein the array comprises a random pattern of regions on the surface or sub-surface of the substrate polymer.

127. The method of claims 125 or 126, wherein the pattern is homogenous.

128. The method of claims 125 or 126, wherein the pattern is heterogenous.

129. The method of claim 96, wherein the hybrid polymer has a mouldable shape.

130. The method of claim 129, wherein the shape is a cylinder, film, sheet, bead or disc.

131. The method of claim 96, wherein the hybrid polymer is macroporous.

132. The method of claim 96, wherein the hybrid polymer is used as a substrate for subsequent grafting.

133. The method of claim 132, wherein the subsequent grafting comprises the addition of one or more olefinically-unsaturated monomers.

134. The method of claim 133, wherein the one or more olefinically-unsaturated monomers are selected from the list comprising methyl methacrylate, ethyl methacrylate, propyl methacrylate including all isomers thereof, butyl methacrylate including all isomers thereof, other alkyl methacrylates, corresponding acrylates, functionalized methacrylates and acrylates fluoroalkyl (meth)acrylates, methacrylic acid, acrylic acid, fumaric acid and esters thereof, itaconic acid and esters thereof, nucleic anhydride, styrene, .alpha.-methyl styrene, vinyl halides, acrylonitrile, methacrylonitrile, vinylidene halides of formula CH₂—C (Hal)₂ wherein each halogen is independently Cl or F, optionally substituted butadiene of the formula CH₂═C(R₁)C(R₁)═CH₂ wherein R₁ is independently H, Cl to C₁₀ alkyl, Cl or F, sulphonic acids or derivatives thereof of formula CH₂═CHSO₂OM wherein M is NaS, K, Li, N(R₂)₄, or —(CH₂)₂—D wherein each R₂ is independently H or Cl or C₁₀ alkyl, D is CO₂Z, OH, N(R₂)₂ or SO₂OZ and Z is H. Li, Na, K or N(R₂)₄, acrylamide or derivatives thereof of formula CH₂—C(CH₃)CON(R₂)₂, and/or mixtures thereof.

135. The method of claim 134, wherein the one or more olefinically-unsaturated monomers are selected from the list comprising functionalized methacrylates and styrene.
